(19) United States
(12) Patent Application Publication
(10) Pub. No.: US 2013/0298691 A1
(43) Pub. Date: Nov. 14, 2013

(54) PART FATIGUE FRACTURE EVALUATING APPARATUS, PART FATIGUE FRACTURE EVALUATING METHOD, AND COMPUTER PROGRAM

(71) Applicant: Hiroshi Shimanuki, Tokyo (JP)

(72) Inventor: Hiroshi Shimanuki, Tokyo (JP)

(73) Assignee: NIPPON STEEL & SUMITOMO METAL CORPORATION, Tokyo (JP)

(21) Appl. No.: 13/981,002

(22) PCT Filed: Apr. 27, 2012
(86) PCT No.: PCT/JP2012/061437

§ 371 Date: Jul. 22, 2013

(30) Foreign Application Priority Data
Nov. 7, 2011 (JP) 2011-243790

(51) Int. Cl. G01N 3/02

(52) U.S. Cl. CPC G01N 3/02
USPC 73/788

(57) ABSTRACT

There is derived an index FS (P) obtained by integrating the product of a probability distribution function f (√areaₘₐₓ) of an inclusion size √areaₘₐₓ of a part and a “size S (P, √√areaₘₐₓ) of a region of the part” where a stress amplitude σ of an acting stress exceeds a stress amplitude σ_{w} of a fatigue strength at each location in the case of a load being applied under a loading condition P set previously by an operator over the inclusion size √√areaₘₐₓ of the part with the whole region of a range where a probability distribution of the inclusion size √areaₘₐₓ exists set as an integral range.

### TECHNICAL FIELD

The present invention relates to a part fatigue fracture evaluating apparatus, a part fatigue fracture evaluating method, and a computer program and, particularly to, those that are preferably used to evaluate fatigue inside a machine part subjected to a repeated load.

### BACKGROUND ART

Conventionally, design of machine parts (metal parts and the like) subjected to a repeated load is often made to prevent fatigue fracture thereof. As a conventional typical method for determining an allowable stress for fatigue of such a part, there is a method described in Non-Patent Literature 1 in terms of a spring. Normally, as fatigue characteristics of a material, the allowable stress is determined in each steel type, and thus the method described in Non-Patent Literature 1 is designed to determine the allowable stress by using the steel type. However, as for a steel type in which the allowable stress is not determined, and a special one, their allowable stresses are determined separately. In both cases, the allowable stress is determined by multiplying a fatigue strength obtained based on the achievement of a fatigue test result of the spring by an appropriate safety coefficient. Further, as for other machine parts as well, their allowable stresses are often determined based on a test result of an actual object. However, with regard to a part having a shape having difficulty in being subjected to an experiment, its fatigue strength is obtained from a result of a fatigue test by using a fatigue test piece, which is rotary bending of a flat round bar test piece or the like, and in consideration of stress concentration due to the shape, the fatigue strength as the part is estimated. On this occasion, in the case when it is conceivable that a mean of an acting stress greatly affects the fatigue characteristics, from a fatigue strength (a fatigue limit) of a fatigue test piece obtained in consideration of a mean stress of a fatigue crack occurrence portion (a portion having a maximum stress amplitude) of the part by using a method capable of estimating an effect of a mean stress such as a modified Goodman relationship, the fatigue strength of the part is estimated and an appropriate safety factor is given to the fatigue strength, whereby a fatigue design of the part is made. Further, in this method, as the stress to act on the part, the stress in a portion having the highest risk of fatigue fracture is only evaluated.

Further, in Non-Patent Literature 2, as an expression allowing a fatigue strength of a machine part to be estimated, there is proposed an expression allowing a fatigue strength of a machine part to be obtained only with the size and hardness of an inclusion existing inside a material. Further, in Non-Patent Literature 2, there is also proposed an expression allowing the fatigue strength of the machine part to be corrected in consideration of an effect of a stress ratio of the machine part. Furthermore, there is also proposed a method of formulating a maximum size of an inclusion existing inside the material (maximum inclusion size) that affects a weld fatigue strength and its probability distribution (maximum inclusion distribution) by processing of extreme value statistics.

### CITATION LIST

### Non-Patent Literature

Non-Patent Literature 1: “Spring” Technology Association, third edition, Maruzen, 1982, p. 379-p. 389
Non-Patent Literature 2: “Metal Fatigue: Effect of Small Defects and Inclusions” MURAKAMI Yukitaka, Yokendo, Dec. 25, 2008, OD edition first edition, p. 94-p. 112
Non Patent Literature 3: Weibull statistics of strength data for fine ceramics, JISR1625
Non-Patent Literature 4: “Introduction to life prediction of industrial plant material: application of the extreme value statistical method to corrosion,” KOWAKA Masamichi et al., Japan Society of Corrosion Engineering, Maruzen, 1985
Non-Patent Literature 5: “How to summarize reliability data: usage of double-exponential distribution,” KASE Shigeo, Ohmsha, 1984, p. 57-p. 82
Non-Patent Literature 6: “An Introduction to Statistical Modeling of Extreme Values,” Stuart Coles, Springer-Verlag London Limited, 2001, p. 45-p. 56

### SUMMARY OF INVENTION

### Technical Problem

Incidentally, with regard to a high-strength steel used for a spring or the like, for example, fatigue fracture sometimes occurs starting from an inclusion or the like from the inside of a machine part. It is known that such fatigue fracture occurs by a smaller stress and repeated loading repeated a smaller number of times in terms of fracture mechanics in a part made of a material exhibiting a higher existence probability of an inclusion having a larger size. Further, in the machine part, if a region having a high stress is large, a maximum inclusion size that can exist in the region is increased, and thus a fatigue strength decreases. Further, the machine part receives various stresses such as tension compression-torsion bending, and so on, so that a stress condition varies depending on each place, and further when a residual stress is introduced into the inside of the part by a heat treatment, shot peening, or the like, an internal stress of the machine part varies depending on each place even in a no-loaded state. This internal stress of the machine part in a no-loaded state affects a stress ratio and a mean stress when a repeated load is received. Thus, for evaluating the fatigue of the machine part, both effects of a volume effect (a distribution of an inclusion) and a distribution of the internal stress of the machine part are required to be considered.

However, the safe factor depicted in Non-Patent Literature 1 is not based on any theoretical basis but experientially determined. Thus it is difficult to accurately evaluate the fatigue of the machine part. Further, with regard to the technique described in Non-Patent Literature 1, it is not possible to say that the effect of the volume effect and the effect of the distribution of the internal stress of the machine part are both not considered sufficiently when a fatigue design of the machine part is made.

Further, in Non-Patent Literature 2, it is possible to make a fatigue design of the machine part in consideration of the volume effect affecting a fatigue fracture phenomenon under a uniform stress by the expression allowing the fatigue strength of the machine part to be obtained and the formulation of the maximum inclusion size and the maximum inclusion distribution by the processing of extreme value statistics. However, even in the technique described in Non-Patent Literature 2, it is not possible to make a fatigue design of the machine part in consideration of both the effects of the volume effect and the distribution of the internal stress of the machine part.

The present invention is made in consideration of the problems as above and has an object to make it possible to make a fatigue design of a machine part in consideration of both a distribution of an inclusion existing inside the machine part and a distribution of an internal stress of the machine part.

### Solution to Problem

A part fatigue fracture evaluating apparatus of the present invention being a part fatigue fracture evaluating apparatus evaluating fatigue inside a machine part when being subjected to a repeated load, the part fatigue fracture evaluating apparatus includes: a maximum size inclusion distribution function deriving means that inputs a plurality of values of an inclusion size, each being a value obtained by taking the square root of a cross-sectional area of an inclusion obtained by projecting the shape of, among inclusions existing inside the machine part, the maximum inclusion in a reference volume on a plane, or a value obtained by taking the square root of an estimated value of a cross-sectional area of an inclusion obtained from, in the case when among inclusions existing inside the machine part, the shape of the maximum inclusion in a reference volume is made to approximate a predetermined figure, a representative size of the figure, and based on the input plural inclusion sizes, derives a probability distribution function of the inclusion size with a maximum value distribution, of the inclusion size, in the machine part set to follow a generalized extreme value distribution; an estimated fatigue strength deriving means that inputs values of the inclusion size, hardness of the machine part or strength of a material of the machine part, and a stress ratio of the machine part each and as a fatigue strength, being a fatigue strength starting from an inclusion existing in the machine part, corresponding to a predetermined number of repeated times of a predetermined load to be loaded repeatedly, substitutes the input values in an expression of a fatigue strength expressed by the inclusion size, the hardness of the machine part or strength of the material of the machine part, and the stress ratio of the machine part to derive the fatigue strength at each location of the machine part; an acting stress amplitude deriving means that derives a stress amplitude of an acting stress to act on each location inside the machine part when being subjected to a repeated load under a loading condition set previously; a fatigue strength excess region deriving means that derives the size of, of a region of the machine part, a region where the stress amplitude of the acting stress exceeds the fatigue strength based on a result obtained by comparing the fatigue strength derived by the estimated fatigue strength deriving means and the stress amplitude of the acting stress derived by the acting stress amplitude deriving means; an index deriving means that derives an index for evaluating the fatigue inside the machine part based on the product of the probability distribution function of the inclusion size and the size of the region where the stress amplitude of the acting stress exceeds the fatigue strength; and an index outputting means that outputs the index derived by the index deriving means.

A part fatigue fracture evaluating method of the present invention being a part fatigue fracture evaluating method evaluating fatigue inside a machine part when being subjected to a repeated load by using a computer, the part fatigue fracture evaluating method includes: a maximum size inclusion distribution function deriving step of inputting a plurality of values of an inclusion size, each being a value obtained by taking the square root of a cross-sectional area of an inclusion obtained by projecting the shape of, among inclusions existing inside the machine part, the maximum inclusion in a reference volume on a plane, or a value obtained by taking the square root of an estimated value of a cross-sectional area of an inclusion obtained from, in the case when among inclusions existing inside the machine part, the shape of the maximum inclusion in a reference volume is made to approximate a predetermined figure, a representative size of the figure, and based on the input plural inclusion sizes, deriving a probability distribution function of the inclusion size with a maximum value distribution, of the inclusion size, in the machine part set to follow a generalized extreme value distribution; an estimated fatigue strength deriving step of inputting values of the inclusion size, hardness of the machine part or strength of a material of the machine part, and a stress ratio of the machine part each and as a fatigue strength, being a fatigue strength starting from an inclusion existing in the machine part, corresponding to a predetermined number of repeated times of a predetermined load to be loaded repeatedly, substituting the input values in an expression of a fatigue strength expressed by the inclusion size, the hardness of the machine part or strength of the material of the machine part, and the stress ratio of the machine part to derive the fatigue strength at each location of the machine part; an acting stress amplitude deriving step of deriving a stress amplitude of an acting stress to act on each location inside the machine part when being subjected to a repeated load under a loading condition set previously; a fatigue strength excess region deriving step of deriving the size of, of a region of the machine part, a region where the stress amplitude of the acting stress exceeds the fatigue strength based on a result obtained by comparing the fatigue strength derived by the estimated fatigue strength deriving step and the stress amplitude of the acting stress derived by the acting stress amplitude deriving step; an index deriving step of deriving an index for evaluating the fatigue inside the machine part based on the product of the probability distribution function of the inclusion size and the size of the region where the stress amplitude of the acting stress exceeds the fatigue strength; and an index outputting step of outputting the index derived by the index deriving step.

A computer program product of the present invention being a computer program product for causing a computer to execute evaluation of fatigue inside a machine part when being subjected to a repeated load by using a computer, the computer program product for casing the computer to execute: a maximum size inclusion distribution function deriving step of inputting a plurality of values of an inclusion size, each being a value obtained by taking the square root of a cross-sectional area of an inclusion obtained by projecting the shape of, among inclusions existing inside the machine part, the maximum inclusion in a reference volume on a plane, or a value obtained by taking the square root of an estimated value of a cross-sectional area of an inclusion obtained from, in the case when among inclusions existing inside the machine part, the shape of the maximum inclusion in a reference volume is made to approximate a predetermined figure, a representative size of the figure, and based on the input plural inclusion sizes, deriving a probability distribution function of the inclusion size with a maximum value distribution, of the inclusion size, in the machine part set to follow a generalized extreme value distribution; an estimated fatigue strength deriving step of inputting values of the inclusion size, hardness of the machine part or strength of a material of the machine part, and a stress ratio of the machine part each and as a fatigue strength, being a fatigue strength starting from an inclusion existing in the machine part, corresponding to a predetermined number of repeated times of a predetermined load to be loaded repeatedly, substituting the input values in an expression of a fatigue strength expressed by the inclusion size, the hardness of the machine part or strength of the material of the machine part, and the stress ratio of the machine part to derive the fatigue strength at each location of the machine part; an acting stress amplitude deriving step of deriving a stress amplitude of an acting stress to act on each location inside the machine part when being subjected to a repeated load under a loading condition set previously; a fatigue strength excess region deriving step of deriving the size of, of a region of the machine part, a region where the stress amplitude of the acting stress exceeds the fatigue strength based on a result obtained by comparing the fatigue strength derived by the estimated fatigue strength deriving step and the stress amplitude of the acting stress derived by the acting stress amplitude deriving step; an index deriving step of deriving an index for evaluating the fatigue inside the machine part based on the product of the probability distribution function of the inclusion size and the size of the region where the stress amplitude of the acting stress exceeds the fatigue strength; and an index outputting step of outputting the index derived by the index deriving step.

### Advantageous Effects of Invention

According to the present invention, it is designed to derive an index for evaluating fatigue inside a machine part based on the product of a probability distribution function of an inclusion size and the size of a region of the part where a stress amplitude of an acting stress exceeds a fatigue strength. Thus, it is possible to make a fatigue design of the machine part in consideration of both a distribution of an inclusion existing inside the machine part and a distribution of an internal stress of the machine part.

### BRIEF DESCRIPTION OF DRAWINGS

FIG. 1 is a diagram depicting one example of the hardware configuration of a part fatigue fracture evaluating apparatus;

FIG. 2 is a diagram depicting one example of the functional configuration of the part fatigue fracture evaluating apparatus;

FIG. 3 is a view conceptually depicting one example of the relationship between a cumulative probability and an inclusion size;

FIG. 4 is a flowchart explaining one example of the operation flow of the part fatigue fracture evaluating apparatus;

FIG. 5 is a view depicting Example 1 and depicting the relationship between a distance from a wire surface of a coil spring and a stress amplitude of a residual stress of the coil spring;

FIG. 6 is a view depicting Example 1 and depicting the relationship between a cumulative probability and a normalized variable and an inclusion size;

FIG. 7 is a view depicting Example 1 and depicting the relationship between a stress amplitude of a fatigue strength and a stress amplitude of a shear stress and the distance from the wire surface of the coil spring;

FIG. 8 is a view depicting Example 1 and depicting a graph expressing a probability distribution function, a graph expressing a function indicating the relationship between an area proportion and the inclusion size, and a graph expressing a function obtained by multiplying the probability distribution function and this function;

FIG. 9 is a view depicting Example 1 and depicting the relationship between an index and a nominal maximum shear stress;

FIG. 10 is a view depicting Example 1 and depicting the relationship between the number of fractured coil springs obtained from the result of a fatigue fracture test and a maximum shear stress;

FIG. 11 is a view depicting Example 2 and depicting the relationship between a distance from a surface of a round bar test piece and a stress amplitude of a residual stress of the round bar test piece;

FIG. 12 is a view depicting Example 2 and depicting the relationship between an index and the number of fractured round bar test pieces and a test piece surface stress amplitude; and

FIG. 13 is a view depicting Example 3 and depicting the relationship between an index and the number of fractured round bar test pieces and a test piece surface stress amplitude.

### DESCRIPTION OF EMBODIMENTS

Hereinafter, one embodiment of the present invention will be explained with reference to the drawings.

<Hardware Configuration of a Part (Machine Part) Fatigue Fracture Evaluating Apparatus>

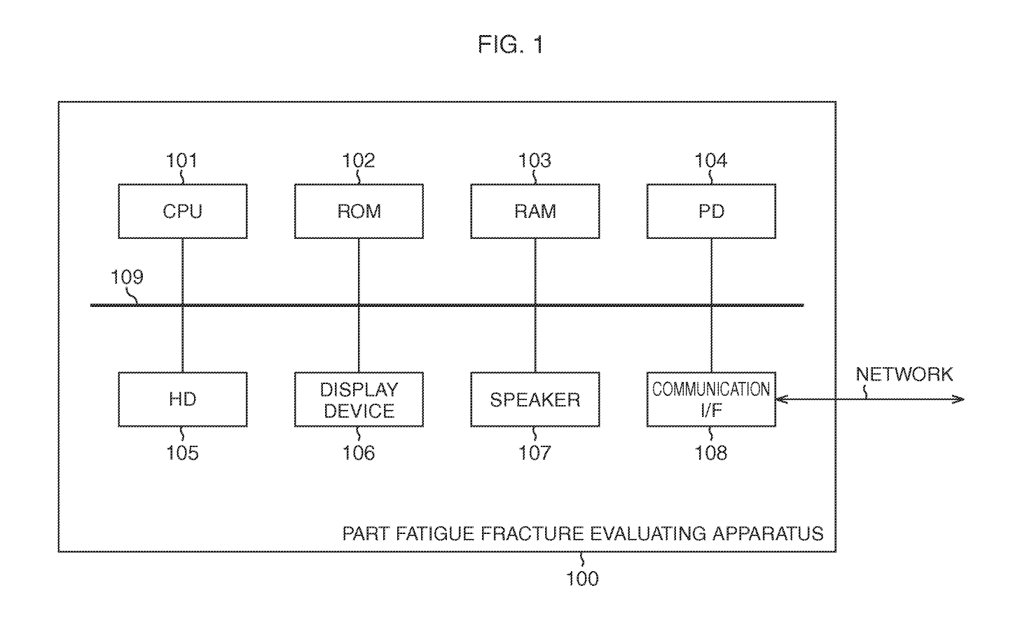

FIG. 1 is a diagram depicting one example of the hardware configuration of a part fatigue fracture evaluating apparatus 100.

As depicted in FIG. 1, the part fatigue fracture evaluating apparatus 100 has a CPU (Central Processing Unit) 101, a ROM (Read Only Memory) 102, a RAM (Random Access Memory) 103, a PD (Pointing Device) 104, an HD (Hard Disk) 105, a display device 106, a speaker 107, a communication IIF (Interface) 108, and a system bus 109.

The CPU 101 is to collectively control the operation in the part fatigue fracture evaluating apparatus 100 and controls respective components (102 to 108) of the part fatigue fracture evaluating apparatus 100 via the system bus 109.

The ROM 102 stores a BIOS (Basic Input/Output System) that is a control program of the CPU 101, an operating system program (OS), and programs necessary for the CPU 101 to execute later-described processing, and so on.

The RAM 103 functions as a main memory, a work area, and the like of the CPU 101. When executing processing, the CPU 101 loads necessary computer programs and the like from the ROM 102 and necessary information and the like from the HD 105 into the RAM 103 and executes processing of the computer programs and the like and the information and the like to thereby implement various operations.

The PD 104 is composed of, for example, a mouse, a keyboard, and the like and constitutes an operation input means for an operator to perform, according to need, an operation input to the part fatigue fracture evaluating apparatus 100.

The HD 105 constitutes a storing means storing various kinds of information, data, files, and the like.

The display device 106 constitutes a display means displaying various kinds of information and images based on the control of the CPU 101.

The speaker 107 constitutes a voice output means outputting voice relating to various kinds of information based on the control of the CPU 101.

The communication I/F 108 performs communication of various kinds of information and the like with an external device over a network based on the control of the CPU 101.

The system bus 109 is a bus for connecting the CPU 101, the ROM 102, the RAM 103, the PD 104, the HD 105, the display device 106, the speaker 107, and the communication I/F 108 such that they can communicate with each other.

<The Part Fatigue Fracture Evaluating Apparatus>

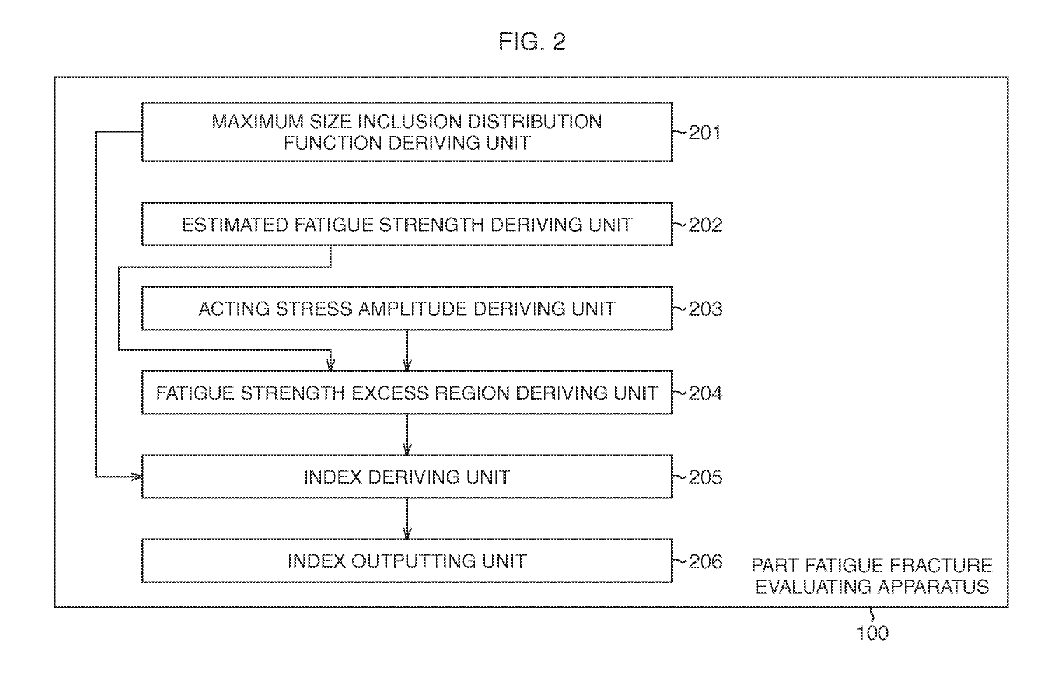

FIG. 2 is a diagram depicting one example of the functional configuration of the part fatigue fracture evaluating apparatus 100.

In FIG. 2, the part fatigue fracture evaluating apparatus 100 includes: a maximum size inclusion distribution function deriving unit 201; an estimated fatigue strength deriving unit 202; an acting stress amplitude deriving unit 203; a fatigue strength excess region deriving unit 204; an index deriving unit 205; and a fatigue strength excess volume probability outputting unit 206.

<The Maximum Size Inclusion Distribution Function Deriving Unit 201>

The maximum size inclusion distribution function deriving unit 201 derives a probability distribution of an inclusion size √areaₘₐₓ [μm] of a machine part being an object for which a fatigue design is made (in the following explanation, the “machine part being an object for which the fatigue design is made” is abbreviated to the “part” according to need). The inclusion size √areaₘₐₓ of the part is called what is called a “root area” and is a value obtained by taking the square root (√) of, among projected areas in the case when shapes of inclusions existing in a certain region (a reference volume) of the part are projected on a plane, the projected area of the inclusion having the maximum projected area. However, it is actually difficult to accurately obtain such an area, so that it is not always necessary to do in this manner. For example, as for this value, it may also be designed that among inclusions existing in a certain region (a reference volume) of the part, the shape of the maximum inclusion is made to approximate a simple figure (shape) such as a quadrangular shape or an elliptical shape and from a representative size of the figure, a projected area of the inclusion is estimated and obtained, and the square root of this area is this value. As a concrete example, in the case when the shape of the maximum inclusion in a certain region (a reference volume) of the part is made to approximate an elliptical shape, it is also possible to set a value obtained by taking the square root of the product of a major axis of the elliptical shape and a minor axis of the elliptical shape to an estimated value of the projected area of the inclusion.

Incidentally, in the present specification, √X is X^{1/2} (the ½th power of X). For example, √areaₘₐₓ represents areaₘₐₓ^{1/2}.

The maximum size inclusion distribution function deriving unit 201 sets a maximum value distribution of the inclusion size √areaₘₐₓ of the part to follow a generalized extreme value distribution.

Thus, a cumulative probability F (√areaₘₐₓ) of the inclusion size √areaₘₐₓ of the part is expressed in (1a) Expression and (1b) below.

F(√areaₘₐₓ)=exp [−{1+ξ((√areaₘₐₓ−λ)/α}]^{-1/ξ}] in the case of ξ≠0 (1a)

F(√areaₘₐₓ)=exp [−exp {−(√areaₘₐₓ−λ)/α}] in the case of ξ=0 (1b)

Further, a probability distribution function f (√areaₘₐₓ) of the inclusion size √areaₘₐₓ of the part is expressed in (2a) Expression and (2b) Expression below. Incidentally, the probability distribution function f (√areaₘₐₓ) of the inclusion size √areaₘₐₓ of the part can be obtained by differentiating (1) Expressions by the inclusion size √areaₘₐₓ of the part.

f(√areaₘₐₓ)=(1/α){1+ξ((√areaₘₐₓ−λ)/α)}^{-1/ξ-1}·exp [−{1+ξ((√areaₘₐₓ−λ)/α)}^{-1/ξ}] in the case of ξ≠0 (2a)

f(√areaₘₐₓ)=(1/α)exp [−(√areaₘₐₓ−λ)/α−exp {−(√areaₘₐₓ−λ)/α}] in the case of ξ=0 (2b)

In (1) Expressions and (2) Expressions, α represents a scale parameter, λ represents a location parameter, and ξ represents a shape parameter. Incidentally, in the following explanation, a “cumulative probability Fⱼ (√areaₘₐₓ) of the inclusion size √areaₘₐₓ of the part” is referred to as the “cumulative probability F (√areaₘₐₓ)” according to need. Further, the “probability distribution function f (√areaₘₐₓ) of the inclusion size √areaₘₐₓ of the part” is referred to as the “probability distribution function f (√areaₘₐₓ)” according to need. Further, the “inclusion size √areaₘₐₓ of the part” is referred to as a “maximum inclusion size √areaₘₐₓ or the inclusion size √areaₘₐₓ” according to need.

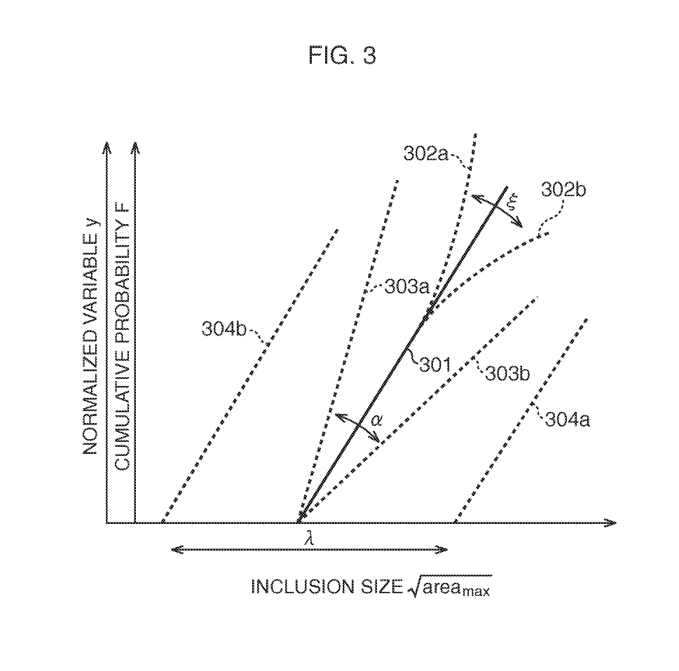

FIG. 3 is a view conceptually depicting one example of the relationship between the cumulative probability F (√areaₘₐₓ) and a normalized variable y (=−ln(−ln(F))) and the inclusion size √areaₘₐₓ of the part. The normalized variable y corresponds to a value obtained by taking a double logarithm of the cumulative probability F (√areaₘₐₓ) (see later-described (3) Expression and (4) Expression).

With reference to FIG. 3, there will be explained the outlines of the scale parameter α, the location parameter λ, and the shape parameter ξ.

In FIG. 3, in the case when the shape parameter ξ becomes zero (ξ=0), a maximum inclusion probability distribution function becomes a straight line such as a graph 301. This graph 301 corresponds to (1b) Expression. (1b) Expression expresses an extreme value distribution called a Gumbel type. (1b) Expression is used in the case when an actual measured value of the maximum inclusion size √areaₘₐₓ is small.

In the case when the shape parameter ξ becomes a negative value (ξ<0), the maximum inclusion probability distribution function is expressed as a graph 302a. As expressed in the graph 302a, the shape parameter ξ being a negative value (ξ<0) indicates that the value of the maximum inclusion size √areaₘₐₓ hits the peak. This graph 302a corresponds to (1a) Expression in which the shape parameter becomes a negative value (ξ<0). (1a) Expression in which the shape parameter ξ becomes a negative value (ξ<0) is an extreme value distribution called a Weibull type.

On the other hand, in the case when the shape parameter ξ becomes a positive value (ξ>0), the maximum inclusion probability distribution function is expressed as a graph 302b. As expressed in the graph 302b, the shape parameter ξ being a positive value (ξ>0) indicates that an inclusion having the large maximum inclusion size √areaₘₐₓ exists in a certain region (in a reference volume) of the part infrequently. This graph 302b corresponds to (1a) Expression in which the shape parameter ξ becomes a positive value (ξ>0). (1a) Expression in which the shape parameter ξ becomes a positive value (ξ>0) is an extreme value distribution called a Frechet type.

Further, in FIG. 3, when the value of the scale parameter α becomes large (as compared with the value of the one corresponding to the graph 301), the maximum inclusion probability distribution function is expressed as a graph 303a. The inclination of the graph 303a becomes steep as compared with the graph 301. As expressed in the graph 303a, the value of the scale parameter α becoming large indicates that the values of the maximum inclusion sizes √areaₘₐₓ extracted from (respective regions each having) a reference volume of the part become values close to one another (that the maximum inclusion sizes √areaₘₐₓ, which are values similar to one another, are extracted from (respective regions each having) a reference volume of the part).

On the other hand, when the value of the scale parameter α becomes small (as compared with the value of the one corresponding to the graph 301), the maximum inclusion probability distribution function is expressed as a graph 303b. The inclination of the graph 303b becomes gentle as compared with the graph 301. As expressed in the graph 303b, the value of the scale parameter α becoming small indicates that the values of the maximum inclusion sizes √areaₘₐₓ extracted from (respective regions each having) a reference volume of the part vary.

Further, in FIG. 3, when the value of the location parameter λ becomes large (as compared with the value of the one corresponding to the graph 301), the maximum inclusion probability distribution function is expressed as a graph 304a. In the graph 304a, the value of the maximum inclusion size √areaₘₐₓ when the cumulative probability F (√areaₘₐₓ) is zero becomes large as compared with the graph 301. As expressed in the graph 304a, the value of the location parameter λ being large indicates that inclusions each having a large size exist averagely in respective (regions each having) a reference volume of the part.

On the other hand, when the value of the location parameter λ becomes small (as compared with the value of the one corresponding to the graph 301), the maximum inclusion probability distribution function is expressed as a graph 304b. In the graph 304b, the value of the maximum inclusion size √areaₘₐₓ when the cumulative probability F (√areaₘₐₓ) is zero becomes small as compared with the graph 301. As expressed in the graph 304b, the value of the location parameter λ being small indicates that inclusions each having a small size exist averagely in respective (regions each having) a reference volume of the part.

The maximum size inclusion distribution function deriving unit 201 derives the scale parameter α, the location parameter λ, and the shape parameter ξ to thereby derive the probability distribution function f (√areaₘₐₓ). The derivations of the scale parameter α and the location parameter λ in the case of the simplest shape parameter ξ being zero (ξ=0) can be achieved by forming an extreme value statistical graph. This method is described in “Metal Fatigue Effect of Small Defects and Inclusions, MURAKAMI Yukitaka, Yokendo, Dec. 25, 2008, OD edition first edition, p. 245 to p. 248.” Hereinafter, the method will be explained briefly.

First, the maximum inclusion size √areaₘₐₓ is measured on each of n pieces of cross sections each having the same size of a single part or a plurality of parts. Here, n is an integer of two or more, and a number necessary for deriving the later-described scale parameter α and location parameter λ (or scale parameter α, location parameter λ, and shape parameter ξ) is selected appropriately. Further, the way of obtaining the cross section is not limited in particular. The maximum size inclusion distribution function deriving unit 201 acquires these values of n pieces of the inclusion sizes √areaₘₐₓ based on the operation of the operator, the communication with an external device, or the like.

Further, as another method for measuring the maximum inclusion size √areaₘₐₓ, it is also possible that plural fatigue test pieces each having the same shape are used and are subjected to a fatigue test, an inclusion size to be the starting point of fatigue fracture to appear in a fracture surface of the fatigue test piece is evaluated as the maximum inclusion size √areaₘₐₓ corresponding to a volume of a high stress region of the fatigue test piece, and then the similar operation is performed. This is because as long as the condition of repeated loading is the same, a fatigue crack first occurs starting from a large inclusion rather than a small inclusion.

The maximum size inclusion distribution function deriving unit 201 calculates a cumulative probability Fⱼ (√area_{max,j}) and a normalized variable yⱼ [−] from (3) Expression and (4) Expression below in a manner to correspond to j (1 to n) in both Expressions.

Fⱼ(√area_{max,j})={j/(n+1)} (3)

yⱼ−ln [−ln {j/(n+1)}] (4)

Further, the way of obtaining the cumulative probability Fⱼ here is explained as a mean rank, but such as a median rank or a symmetric rank, the way of obtaining the cumulative probability Fⱼ may also be changed according to a probability distribution of an experimental result.

The maximum size inclusion distribution function deriving unit 201 aligns n pieces of inclusion sizes √area_{max,j} in ascending order (the minimum inclusion size is set to √area_{max,1} and the maximum inclusion size is set to √area_{max,n}). Then, the maximum size inclusion distribution function deriving unit 201 sets the inclusion size √areaₘₐₓ to a value of the horizontal axis and sets the cumulative probability F (√areaₘₐₓ) and the normalized variable y to a value of the vertical axis and estimates the maximum inclusion probability distribution function indicating the relationship of them by using the maximum likelihood method (see Non-Patent Literature 3), the MVLUE method (see Non-Patent Literatures 4 and 5), the least square method, or the like. Then, the maximum size inclusion distribution function deriving unit 201 derives the scale parameter a from the inclination of the estimated maximum inclusion probability distribution function and derives the location parameter λ0 from the location of the horizontal axis of the maximum inclusion probability distribution function.

On the other hand, in the case when the shape parameter ξ is not zero (ξ≠0), it is possible to derive the scale parameter α, the location parameter λ, and the shape parameter ξ by the maximum likelihood method using the likelihood function depicted on page 45 to page 56 in Non-Patent Literature 6, for example. That is, it is possible that from a likelihood function corresponding to a function form of (1a) Expression, a log likelihood function is formed and the scale parameter α, the location parameter λ, and the shape parameter ξ when the value of this likelihood function becomes maximum are derived. Incidentally, this method is applicable also in the case of the shape parameter ξ being zero (ξ=0).

The maximum size inclusion distribution function deriving unit 201 performs parameter fitting on measured values of n pieces of the inclusion sizes √areaₘₐₓ by the previously described method and derives the scale parameter α and the location parameter λ (or the scale parameter α, the location parameter λ, and the shape parameter ξ). The maximum size inclusion distribution function deriving unit 201 can, by using, of (1a) Expression and (1b) Expression, the expression set previously by the operator, derive the parameters most suitable for the measured values of n pieces of the inclusion sizes √areaₘₐₓ. Further, the maximum size inclusion distribution function deriving unit 201 can also, by using both (1a) Expression and (1b) Expression, derive the parameters most suitable for the measured values of n pieces of the inclusion sizes √areaₘₐₓ.

The maximum size inclusion distribution function deriving unit 201 is fabricated in a manner that, for example, the CPU 101 executes the programs stored in the ROM 102 to perform the identification of operation contents to the PD 104, the communication with an external device via the communication I/F, and the like, reads the necessary data from the HD 105 and the like, and derives the scale parameter α and the location parameter λ (or the scale parameter α, the location parameter λ, and the shape parameter ξ) to store them in the RAM 103 and the like.

<The Estimated Fatigue Strength Deriving Unit 202>

In this embodiment, it is set that a stress amplitude σ_{w} [N/mm²] of a fatigue strength, being a fatigue strength starting from an inclusion existing in the part, corresponding to a predetermined number of repeated times when a predetermined load is loaded on the part repeatedly is expressed by a function of the inclusion size √areaₘₐₓ, Vickers hardness Hv, and a stress ratio R [−]. Incidentally, in the following explanation, the “stress amplitude σ_{w} of the fatigue strength, being a fatigue strength starting from an inclusion existing in the part such as a steel material, corresponding to a predetermined number of repeated times when a predetermined load is loaded on the part repeatedly” is abbreviated to the “stress amplitude σ_{w} of the fatigue strength” according to need.

In this embodiment, it is set that the predetermined number of repeated times of the load to be loaded on the part repeatedly is assumed to be 10⁷ times and as is in (5) Expression below, the stress amplitude σ_{w} of the fatigue strength is expressed.

σ_{w}={1.56×(Hv+120)/(√areaₘₐₓ)^{1/6}}×{(1−R)/2}^{γ} (5)

Incidentally, (5) Expression above is an expression allowing a fatigue limit to be estimated originally, but is used as an expression of the fatigue strength in 10⁷ times or so in consideration of the ability of a testing machine at the time of research and the like.

In (5) Expression, Hv is the Vickers hardness. Further, R is the stress ratio and is expressed by (6) Expression below. Further, γ is an influence multiplier of hardness and is expressed by (7) Expression below.

R=(σₘ−σ_{w})/(σₘ+σ_{w}) (6)

γ=0.226+Hv/10000 (7)

In (6) Expression, σₘ is a stress amplitude [N/mm²] of a mean stress of the part.

The values of the Vickers hardness Hv and the inclusion size √areaₘₐₓ can be obtained from the result of a test of a material constituting the part. Further, the values of the mean stress σₘ of the part and the stress ratio R can be obtained from the load to be loaded on the part and a size of the part. In this embodiment, as the stress ratio R, a stress ratio of a corresponding stress at each location inside the part, or a stress ratio of a principal stress in a direction in which variation in the principal stress at each location inside the part becomes maximum is employed. It is possible to appropriately determine which to employ between the stress ratios according to the part and the like.

The estimated fatigue strength deriving unit 202, based on the operation by the operator and the like, inputs these values to perform the calculation of (5) Expression and derives the stress amplitude σ_{w} of the fatigue strength at each location inside the part when being subjected to the predetermined repeated load the predetermined number of repeated times in a manner to correspond to the stress ratio R at the location.

In this embodiment, such plural stress amplitudes σ_{w} of the fatigue strength are derived in a manner to vary the inclusion size √areaₘₐₓ and the stress ratio R of which the value changes according to a location of the part and a condition of used stress each. This makes it possible to derive the stress amplitude σ_{w} of the fatigue strength in each of the inclusion sizes √areaₘₐₓ of the inclusions existing inside the part and at each location of the part.

Incidentally, in this embodiment, the stress amplitude σ_{w} of the fatigue strength is designed to be derived from (5) Expression, but as long as it is designed that the stress amplitude σ_{w} of the fatigue strength is expressed by the function of the inclusion size √areaₘₐₓ, the Vickers hardness Hv, and the stress ratio R, the stress amplitude σ_{w} of the fatigue strength is not necessarily expressed by (5) Expression. For example, as described in “Effect of inclusion on rotating bending fatigue strength of carburized and shot-peened steels for gear use, MATSUMOTO el al., Proceedings of material mechanics conference of The Japan Society of Mechanical Engineers, No. 900-86, 1990, p. 275-p. 277,” it is also possible to design so that the stress amplitude of the fatigue strength may be expressed by (8) Expression below.

σ_{w}={1.56×(Hv+120)/(√areaₘₐₓ)^{1/6}}−0.5×σₘ (8)

Incidentally, in (8) Expression, not the stress ratio R but the stress amplitude σₘ of the mean stress of the part is used to express the stress amplitude σ_{w} of the fatigue strength. However, as expressed in (6) Expression, the stress amplitude σₘ of the mean stress of the part can be expressed by using the stress amplitude σ_{w} of the fatigue strength and the stress ratio R, so that it is equivalent that (8) Expression is a function of the stress ratio R. Furthermore, it is also possible to change the coefficients depicted in (5) Expression and (8) Expression.

Further, the Vickers hardness Hv depicted in (5) Expression and (8) Expression has a correlation with the strength [N/mm²] of the material of the part. Thus, it is also possible to design so that the stress amplitude σ_{w} of the fatigue strength may be expressed by using the strength of the material of the part in place of the Vickers hardness Hv. Further, (5) Expression and (8) Expression are general expressions relating to iron and steel materials, and thus if these expressions are corrected to set the stress ratio, the hardness, and the inclusion size to parameters and a function corresponding to the fatigue characteristics of the material to be evaluated is formed and used, higher accuracy can be achieved.

The estimated fatigue strength deriving unit 202 is fabricated in a manner that, for example, the CPU 101 executes the programs stored in the ROM 102 to perform the identification of operation contents to the PD 104 and the like, reads the necessary data from the HD 105 and the like, and derives the stress amplitude σ_{w} of the fatigue strength to store it in the RAM 103 and the like.

<The Acting Stress Amplitude Deriving Unit 203>

The acting stress amplitude deriving unit 203 derives a stress amplitude σ of an acting stress to act on each location of the part when being subjected to the repeated load under a loading condition P set previously by the operator. Incidentally, in the following explanation, the “stress amplitude σ of the acting stress to act on each location of the part when being subjected to the repeated load under the loading condition P set previously by the operator” is abbreviated to the “stress amplitude σ of the acting stress to act on each location of the part” or the “stress amplitude σ of the acting stress” according to need. Here, the loading condition P is to indicate what kind of repeated load is applied on the part.

The acting stress amplitude deriving unit 203 inputs part information such as the shape of the part, the loading condition P, and the strength of the material constituting the part (for example, tensile strength, yield strength, and work hardening property). The acting stress amplitude deriving unit 203 acquires these pieces of part information based on the operation of the operator, the communication with an external device, and the like.

Then, the acting stress amplitude deriving unit 203 uses the acquired part information to derive a change in each stress component at each location (a predetermined location) of the part when being subjected to the repeated load under the loading condition P set previously by the operator. The change in each stress component at each location of the part can be derived by performing analysis using, for example, the FEM (Finite Element method) or the BEM (Boundary element method), or performing calculation using a method of material mechanics. Further, there is sometimes a case that a heat treatment, plastic working, a shot peening process, and so on are performed on the part and thus even in a no-loaded state (a state where no load is applied), an internal stress occurs in the part. This internal stress can be measured by a method of alternately performing X-ray residual stress measurement and electrolytic polishing, or the like. This internal stress in a no-loaded state is added to the change in each stress component at each location of the part when being subjected to the repeated load under the loading condition P set previously by the operator by using a method of material mechanics, and thereby it is possible to make the fatigue design in consideration of also this internal stress in a no-loaded state.

Then, the acting stress amplitude deriving unit 203 employs, as the stress amplitude σ of the acting stress, the amplitude of the corresponding stress at each location inside the part or the amplitude of the principal stress in a direction in which the variation in the principal stress at each location inside the part becomes maximum, for example, from the change in each stress component at each location of the part that is derived as above. It is possible to appropriately determine which to employ between them according to the part and the like.

In this embodiment, such plural stress amplitudes σ of the acting stress are derived in a manner to vary the location of the part. This makes it possible to derive the stress amplitude σ of the acting stress at each location of the part.

Incidentally, it is possible to set ½ of a corresponding stress based on a value obtained by subtracting a minimum value from a maximum value of an amplitude of the load to be applied on the part to the stress amplitude σ of the acting stress, or it is also possible to set ½ of a value obtained by subtracting a corresponding stress based on the minimum value of the amplitude of the load from a corresponding stress based on the maximum value of the amplitude of the load to be applied on the part to the stress amplitude σ of the acting stress.

The acting stress amplitude deriving unit 203 is fabricated in a manner that, for example, the CPU 101 executes the programs stored in the ROM 102 to perform the identification of operation contents to the PD 104, the communication with an external device via the communication I/F, and the like, reads the necessary data from the HD 105 and the like, and derives the stress component σ of the acting stress to store it in the RAM 103 and the like.

<The Fatigue Strength Excess Region Deriving Unit 204>

The fatigue strength excess region deriving unit 204 reads the “stress amplitude σ_{w} of the fatigue strength at each location of the part” and the “stress amplitude σ of the acting stress at each location of the part under the loading condition P set previously by the operator.” Then, the fatigue strength excess region deriving unit 204 compares these values at the same location. Then, the fatigue strength excess region deriving unit 204 derives a size S (P, √areaₘₐₓ) of a “region of the part” where the stress amplitude σ of the acting stress exceeds the stress amplitude σ_{w} of the fatigue strength at each location of the part when being subjected to the load under the loading condition P set previously by the operator. Incidentally, in the following explanation, the “size S (P, √areaₘₐₓ) of the “region of the part” where the stress amplitude σ of the acting stress exceeds the stress amplitude σ_{w} of the fatigue strength at each location of the part when being subjected to the load under the loading condition P set previously by the operator” is referred to as the “size S (P, √areaₘₐₓ) of the region of the part” according to need.

The “size S (P, √areaₘₐₓ) of the region of the part” is expressed in a volume [mm³]. But, in the case when the state of a stress at each location on a cross section obtained by cutting, in a direction perpendicular to an extending direction of a member constituting the part, the member is regarded as the same on any cross section, the “size S (P, √areaₘₐₓ) of the region of the part” can be expressed in an area [mm²]. This is because if the area is multiplied by the length, of the member constituting the part, in the extending direction, volume information can be obtained. One example of such a part is a coil spring. In the case of the part being a coil spring, the extending direction of the member constituting the part is a circumferential direction (a helical direction) of a wire constituting the coil spring. Further, in the case when the “size S (P, √areaₘₐₓ) of the region of the part” is expressed in an area, it is also possible to design so that the “size S (P, √areaₘₐₓ) of the region of the part” may be expressed in a value [−] obtained by dividing the area of the region where the stress amplitude σ of the acting stress exceeds the size of the stress amplitude σ_{w} of the fatigue strength by a cross-sectional area of a “cross section of the part” including the region.

The fatigue strength excess region deriving unit 204 derives the “size S (P, √areaₘₐₓ) of the region of the part” in each of the inclusion sizes √areaₘₐₓ to thereby derive the “size S (P, √areaₘₐₓ) of the region of the part” in a manner to correspond to each of the inclusion sizes √areaₘₐₓ.

The fatigue strength excess region deriving unit 204 is fabricated in a manner that, for example, the CPU 101 executes the programs stored in the ROM 102, reads the necessary data from the RAM 103, the HD 105, and the like, and derives the “size S (P, √areaₘₐₓ) of the region of the part” to store it in the RAM 103 and the like.

<The Index Deriving Unit 205>

The index deriving unit 205 substitutes the “scale parameter α and the location parameter λ” derived by the maximum size inclusion distribution function deriving unit 201 in (2) Expression to set the probability distribution function f (√areaₘₐₓ). Then, the index deriving unit 205 performs calculation of (9) Expression below to derive an index FS (P).

FS(P)=∫f(√areaₘₐₓ)·S(P,√areaₘₐₓ)d√areaₘₐₓ (9)

In (8) Expression, the integral range is the whole region of a range where the probability distribution of the inclusion size √areaₘₐₓ exists. But, it is not always necessary to set the whole region of the range where the probability distribution of the inclusion size √areaₘₐₓ exists to an object for the calculation of the index FS (P). For example, even though no calculation is performed in terms of a place (region) where no fatigue fracture is caused due to the acting stress being small, the difference of the value of the index FS (P) caused by the fact that no calculation is performed falls within an error range, and thus it is also possible to design so that such a place may be excluded from the object for the calculation of the index FS (P).

This index FS (P) becomes an index indicating the size of a “risk region (volume or area) of the part” corresponding to the stress amplitude σ of the acting stress to act repeatedly on a certain place of the part when being subjected to the load under the loading condition P set previously by the operator (under a condition of a certain residual stress existing). As depicted in (8) Expression, the probability distribution function f (√areaₘₐₓ) and the “size S (P, √areaₘₐₓ) of the region of the part” are multiplied, and thereby the “size S (P, √areaₘₐₓ) of the region of the part” can be expressed in consideration of an existence probability of the inclusion. For example, it is possible to compare the values of the indices FS (P) obtained under a plurality of conditions to judge the part under the condition making the value of the index FS (P) minimum as a part having a small possibility of fatigue fracture. In this manner, by making the value of the index FS (P) small, it is possible to design a part having a small possibility of fatigue fracture in consideration of the strength of the material relating to fatigue, the characteristic of the probability distribution of the inclusion, a stress condition when the part is used, and the characteristic of the probability distribution of the residual stress comprehensively. Here, the risk region is a region where the stress amplitude σ of the acting stress on the place exceeds the size of the stress amplitude σ_{w} of the fatigue strength.

Incidentally, in this embodiment, the index FS (P) is designed to be derived, but it is not always necessary to derive the index FS (P). For example, it is also possible that the probability distribution function f (√areaₘₐₓ) and S (P, √areaₘₐₓ) are multiplied to derive a function fs of the inclusion size √areaₘₐₓ of the part, and the maximum value of this function fs is set to the previously described index.

The index deriving unit 205 is fabricated in a manner that, for example, the CPU 101 executes the programs stored in the ROM 102, reads the necessary data from the RAM 103, the HD 105, and the like, and derives the index FS (P) to store it in the RAM 103 and the like.

<The Index Outputting Unit 206>

The index outputting unit 206, based on instructions by the operator, displays the value of the index FS (P) derived in the index deriving unit 205 on the display device, transmits it to an external device, and stores it in a storage medium.

The index outputting unit 206 is fabricated in a manner that, for example, the CPU executes the programs stored in the ROM 102, forms display data for displaying the value of the index FS (P) stored in the RAM 103 and the like to output it to the display device 106, transmits the index FS (P) stored in the RAM 103 and the like to an external device via the communication I/F 108, and stores the index FS (P) stored in the RAM 103 and the like in the HD 105 and a not-illustrated portable storage medium.

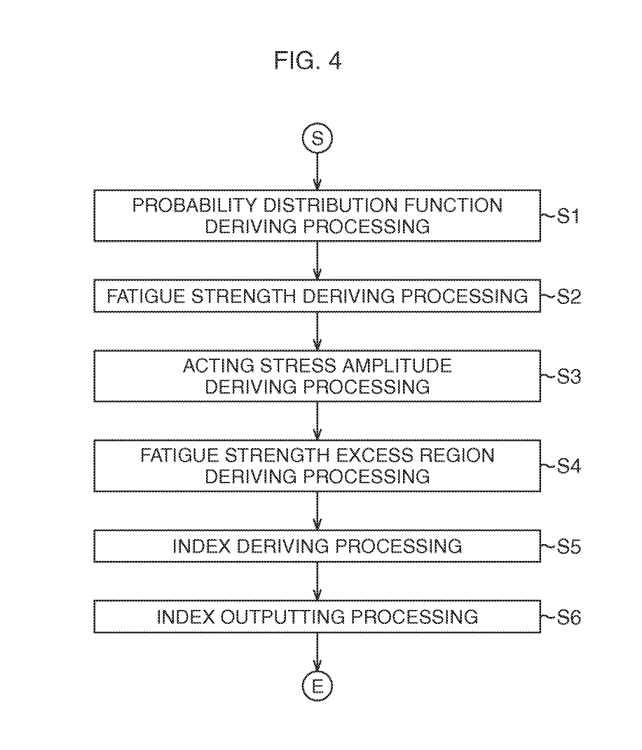

Next, there will be explained one example of the operation flow of the part fatigue fracture evaluating apparatus 100 with reference to a flowchart in FIG. 4.

First, at Step S1, the maximum size inclusion distribution function deriving unit 201 executes probability distribution function deriving processing. Concretely, the maximum size inclusion distribution function deriving unit 201 acquires the values of n pieces of the inclusion sizes √areaₘₐₓ, calculates the cumulative probability Fⱼ (√area_{max,j}) and the normalized variable yⱼ, estimates the maximum inclusion probability distribution function indicating the relationship between the cumulative probability Fⱼ (√area_{max,j}) and the normalized variable yⱼ and the inclusion size √areaₘₐₓ, and derives the scale parameter α and the location parameter λ (or the scale parameter α, the location parameter λ, and the shape parameter ξ) from the estimated maximum inclusion probability distribution function.

Next, at Step S2, the estimated fatigue strength deriving unit 202 executes fatigue strength deriving processing. Concretely, the estimated fatigue strength deriving unit 202 acquires the values of the Vickers hardness Hv, the inclusion size √areaₘₐₓ, the mean stress σₘ of the part, and the stress ratio R to perform the calculation of (5) Expression to thereby derive the stress amplitude σ_{w} of the fatigue strength corresponding to the predetermined number of repeated times when the predetermined load is repeatedly loaded on the part.

Next, at Step S3, the acting stress amplitude deriving unit 203 executes acting stress amplitude deriving processing. Concretely, the acting stress amplitude deriving unit 203 acquires the part information, uses the acquired part information to derive the change in each stress component at each location of the part when being subjected to the repeated load under the loading condition P set previously by the operator, and from the derived change in each stress component at each location of the part, derives the stress amplitude σ of the acting stress to act on each location of the part when being subjected to the repeated load under the loading condition P set previously by the operator.

Next, at Step S4, the fatigue strength excess region deriving unit 204 executes fatigue strength excess region deriving processing. Concretely, the fatigue strength excess region deriving unit 204 compares the values at the same location of the “stress amplitude σ_{w} of the fatigue strength at each location of the part” and the “stress amplitude σ of the acting stress at each location of the part under the loading condition P set previously by the operator” to derive the “size S (P, √areaₘₐₓ) of the region of the part.”

Next, at Step S5, the index deriving unit 205 executes index deriving processing. Concretely, the index deriving unit 205 substitutes the “scale parameter α and the location parameter λ” derived at Step S1 in (2) Expression to set the probability distribution function f (√areaₘₐₓ) and applies the set probability distribution function f (√areaₘₐₓ) and the “size S (P, √areaₘₐₓ) of the region of the part” derived at Step S4 to (9) Expression to derive the index FS (P).

Next, at Step S6, the index outputting unit 206 executes index outputting processing. Concretely, the index outputting unit 206, based on instructions by the operator, displays the value of the index FS (P) derived at Step S5 on the display device, transmits it to an external device, and stores it in a storage medium.

As described above, this embodiment is designed to derive the index FS (P) obtained by integrating the product of the probability distribution function f (√areaₘₐₓ) of the inclusion size √areaₘₐₓ of the part and the size S (P, √areaₘₐₓ) of the “region of the part” where the stress amplitude σ of the acting stress exceeds the size of the stress amplitude σ_{w} of the fatigue strength at each location of the part when being subjected to the load under the loading condition P set previously by the operator over the inclusion size √areaₘₐₓ of the part with the whole region of an evaluation range where the probability distribution of the inclusion size √areaₘₐₓ exists set as an integral range. This makes it possible to make the fatigue design of the part in consideration of both the probability distribution of the inclusion existing inside the part (the existent probability in each size) and the distribution of the internal stress of the part. Thus, it becomes possible to evaluate the fatigue fracture of the part aiming at judging the fatigue fracture more reasonably than ever before.

In a low-strength steel, for example, an inclusion hardly causes the fatigue fracture and the fatigue fracture often occurs only in a place with a strict stress condition, and thus if the stress condition of the place is only evaluated, the fatigue characteristic of the part can be predicted. In contrast to this, in a high-strength steel, for example, a fatigue crack occurs from an inclusion, and thus how the size of an inclusion is distributed becomes important in the case when the fatigue fracture of the part is evaluated. That is, if there is no inclusion even though the stress is large, the part is not likely to be broken, and in the case when a large inclusion exists even though the stress is small, there is a possibility that the part is broken. In this embodiment, the index FS (P) having both the probability distribution of the inclusion (the probability distribution function f (√areaₘₐₓ)) and the size S (P, √areaₘₐₓ) of the region of the part as variables is derived, so that it is possible to make the fatigue design of the part using a high-strength steel much more reasonably than ever before.

### Example 1

Next, examples of the present invention will be explained. First, as Example 1, the example in the case where the stress amplitude σ of the acting stress is a stress amplitude τₐ (r) of a shear stress will be explained.

In this example, as the part, a coil spring having had a compressive residual stress introduced to a surface thereof was used. As the material constituting the coil spring, a high-tensile spring steel having a strength of 1800 [MPa] class (the Vickers hardness Hv=627) was used. This material is known that fatigue fracture stating from an inclusion existing inside the material occurs. Here, r of the stress amplitude τₐ (r) of the shear stress represents a distance from the center of a wire of the coil spring in a circumferential direction of the coil spring.

In this example, coil springs having a wire diameter of 3.3 [mm], an outer diameter of 22 [mm], and the numbers of windings of 30 and 6 were made of this material. Each of these coil springs had a similar shot peening process performed thereon and had a residual stress introduced to a surface thereof.

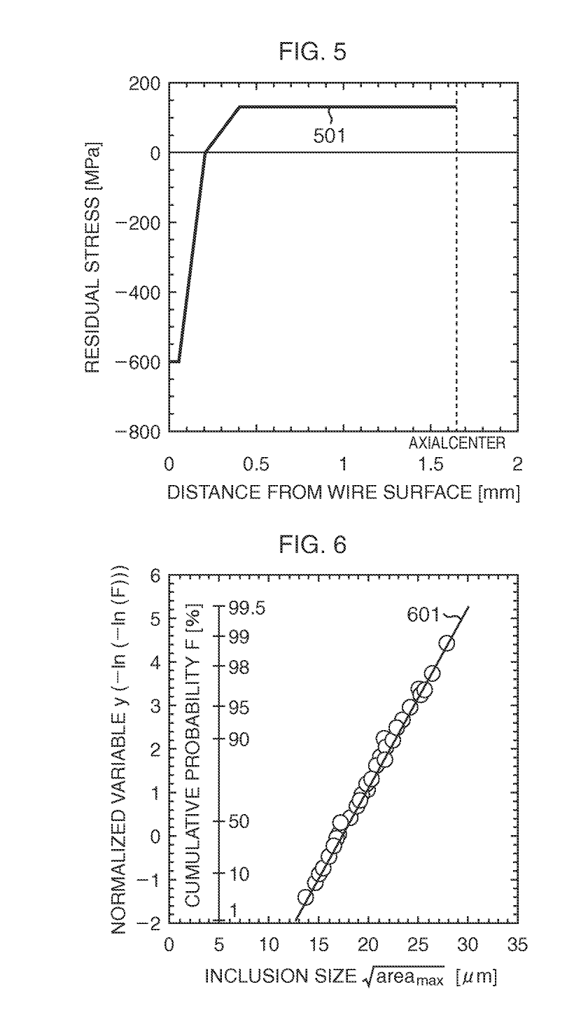

FIG. 5 is a view depicting the relationship between the distance (a depth) from the wire surface of the coil spring and a stress amplitude of the residual stress of the coil spring. In this example, a residual stress 501 depicted in FIG. 5 is introduced to the coil spring.

By using a material similar to that of the coil spring formed of the previously described material, 40 pieces of round bar fatigue test pieces each having a parallel portion of 3.3 [mm] in diameter were made so as to allow a fatigue test to be performed by axial force. Incidentally, a residual stress introduction process by shot peening is not performed on each of the round bar fatigue test pieces. A fatigue test with the stress ratio R=−1 was performed by using 40 pieces of the round bar fatigue test pieces (material fatigue test pieces). Then, the inclusion size √areaₘₐₓ was measured on each of cross sections of 40 pieces of the fatigue test pieces. Here, the shape of an inclusion being the starting point of a fatigue fracture portion was projected on a fracture surface, and a value obtained by taking the square root of an area of the inclusion made to approximate an elliptical shape was measured as the inclusion size √areaₘₐₓ.

The maximum size inclusion distribution function deriving unit 201 inputs the inclusion sizes √area_{max,j} measured in this manner and calculates the cumulative probability Fⱼ (√area_{max,j}) and the normalized variable yⱼ from (3) Expression and (4) Expression.

The maximum size inclusion distribution function deriving unit 201 aligns the input inclusion sizes √area_{max,j} in ascending order and sets the inclusion size √areaₘₐₓ to the value of the horizontal axis and sets the cumulative probability F (√areaₘₐₓ) and the normalized variable y to the value of the vertical axis to estimate a maximum inclusion probability distribution function indicating the relationship of them by using a straight-line approximation by the maximum likelihood method.

FIG. 6 is a view depicting the relationship between the cumulative probability F (√areaₘₐₓ) and the normalized variable y and the inclusion size √areaₘₐₓ. In this example, a maximum inclusion probability distribution function (a straight line) 601 depicted in FIG. 6 was obtained.

The maximum size inclusion distribution function deriving unit 201 derived the scale parameter α and the location parameter λ from the maximum inclusion probability distribution function 601. Here, as depicted in FIG. 6, when the input inclusion sizes √areaₘₐₓ were expressed linearly and the cumulative probability F (√areaₘₐₓ) was expressed in a double logarithm, the linear distribution was obtained, and thus this distribution was thought to be the shape parameter being zero (ξ=0), namely to be the Gumbel-type extreme value distribution and by using (1b) Expression, parameters of the maximum inclusion probability distribution function were estimated.

In this example, a possibility of the fatigue fracture of the coil spring when being subjected to a constant load amplitude repeatedly to be used was examined.

In this example, it was designed that based on the loading condition P (a loading condition of loading a load in an extending and contracting direction of the coil spring so that the maximum shear stress may be a nominal maximum shear stress τₘₐₓ of the spring surface and the minimum shear stress may be ¼ of the nominal maximum shear stress τₘₐₓ of the spring surface), the distribution of the stress amplitude σ of the acting stress (on the coil spring) is derived and the distribution of the residual stress (on the coil spring) is input to combine them, and thereby a stress amplitude of an internal stress of the coil spring is obtained and from the distribution of the stress amplitude, a mean and an amplitude of a maximum principal stress at each location inside the coil spring are obtained, and then the stress ratio R is further obtained. In this example, it is designed that repeated torsion by the repeated loading and the residual stress only act on the coil spring and a residual stress σᵣ does not act in a radial direction of the wire and thereby a maximum σₚ₁ and a minimum σₚ₂ of the maximum principal stress are expressed in (10) Expression and (11) Expression below respectively. Further, it is designed that the stress ratio R is expressed in (12) Expression below.

The fatigue strength deriving unit 202 assumed the inclusion size √areaₘₐₓ that may exceed the fatigue strength in consideration of a possibility of the inclusion having the size existing and a stress level of a member to be evaluated, varied the inclusion size √areaₘₐₓ at intervals of 0.5 [μm] to 1 [μm] in a range of 10 [μm] to 50 [μm], and substituted the stress ratio R provided by (12) Expression in the case of the inclusion size √areaₘₐₓ and the Vickers hardness Hv in (5) Expression and thereby derived the stress amplitude σ_{w} of the fatigue strength.

σₚ₁={(σ₁+σ_{θ})/2}+√[{(σ₁−σ_{θ})/2}²+τ²]=σᵣ+τ (10)

σₚ₂={(σ₁+σ_{θ})/2}+√[{(σ₁−σ_{θ})/2}²+(τ/4)²]=σᵣ+σ/4 (11)

R=(σᵣ+τ/4)/(σᵣ+τ) (12)

In (10) Expression to (12) Expression, σ₁ is an axial stress amplitude [N/mm²] of the coil spring and σ₆ is a circumferential stress amplitude [N/mm²] of the coil spring. τ represents the shear stress [N/mm²] of the coil spring and is expressed as a function of the distance from the axial center of the wire of the coil spring.

When the stress amplitude τₐ (r) of the acting shear stress in this example is rewritten into the stress amplitude σ of the acting stress by the corresponding stress, (13) Expression below is made. The acting stress amplitude deriving unit 203 derives the stress amplitude σ of the acting stress by (13) Expression.

σ=√3·(σₚ₁−σₚ₂)/2=√3·(τ−τ/4)/2=(3/4)·√3·τₐ(r) (13)

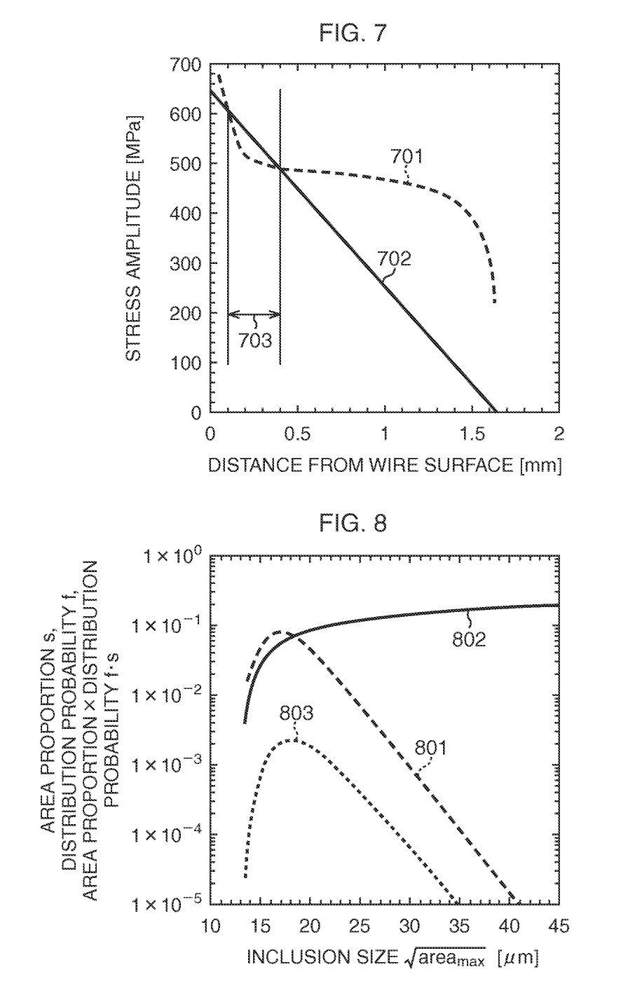

FIG. 7 is a view depicting the relationship between the stress amplitude σ_{w} of the fatigue strength derived from the estimated fatigue strength deriving unit 202 as above and the stress amplitude σ of the acting stress derived from the acting stress amplitude deriving unit 203 and the distance from the wire surface of the coil spring. FIG. 7 depicts a “graph 701 of the stress amplitude σ_{w} of the fatigue strength and a graph 702 of the stress amplitude σ of the acting stress” derived by a certain nominal maximum shear stress τ on the surface of the coil spring. In this example, in terms of each of the stress amplitudes τₐ (r) of the acting shear stress in the case of the maximum shear stress being the nominal maximum shear stress τₘₐₓ on the surface of the coil spring (850 [MPa], 900 [MPa], 950 [MPa], and 1000 [MPa]) and the minimum shear stress being ¼ of the nominal maximum shear stress τₘₐₓ on the surface of the coil spring (212.5 [MPa], 225 [MPa], 237.5 [MPa], and 250 [MPa]), the stress amplitude σ of the acting stress as depicted in FIG. 7 was derived.

The fatigue strength excess region deriving unit 204 compares the “values at the same location” of the “stress amplitude σ_{w} of the fatigue strength at each distance from the wire surface of the coil spring and the stress amplitude σ of the acting stress at each distance from the wire surface of the coil spring under the loading condition P” and derives an “area S (P, √areaₘₐₓ) of a region of the coil spring” where the stress amplitude σ of the acting stress exceeds the stress amplitude σ_{w} of the fatigue strength at each location of the wire in the case of the repeated load being applied under the loading condition P. More concretely, in FIG. 7, the fatigue strength excess region deriving unit 204 compares the graph 701 indicating the stress amplitude σ_{w} of the fatigue strength and the graph 702 indicating the stress amplitude σ of the acting stress and derives a “range 703 of the distance from the wire surface of the coil spring” where the stress amplitude σ of the acting stress exceeds the stress amplitude σ_{w} of the fatigue strength in the case of the repeated load being applied in the extending and contracting direction of the coil spring under the previously described loading condition P at each location of the wire. Then, the fatigue strength excess region deriving unit 204 derives an area of a region of the range 703 of the distance from the wire surface of the coil spring on a cross section of the wire obtained by cutting the wire of the coil spring in a direction perpendicular to the circumferential direction (the helical direction) of the wire as the area S (P, √areaₘₐₓ).

As described above, the stress amplitudes σ_{w} of the fatigue strength when the inclusion size √areaₘₐₓ is varied at intervals of 0.5 [μm] to 1 [μm] in the range of 10 [μm] to 50 [μm] are derived. Thus, in this example, with respect to the single nominal maximum shear stress τ, the areas S (P, √areaₘₐₓ) equivalent to the number of the inclusion sizes √areaₘₐₓ employed for deriving the stress amplitude σ_{w} of the fatigue strength are derived.

The index deriving unit 205 substitutes the “scale parameter α and the location parameter λ” derived from the maximum inclusion probability distribution function 601 depicted in FIG. 6 by the maximum size inclusion distribution function deriving unit 201 in (2) Expression and sets the probability distribution function f (√areaₘₐₓ). Then, the index deriving unit 205 derives a function S (√areaₘₐₓ) indicating the relationship between the area S and the inclusion size √areaₘₐₓ from the area S in each of the inclusion sizes √areaₘₐₓ. Then, the index deriving unit 205 derives a function fS (√areaₘₐₓ) obtained by multiplying the probability distribution function f (√areaₘₐₓ) and this function S (√areaₘₐₓ).

FIG. 8 is a view depicting a graph 801 expressing the probability distribution function f (√areaₘₐₓ), a graph 802 expressing a function s (√areaₘₐₓ) indicating the relationship between an area proportion s and the inclusion size √areaₘₐₓ, and a graph 803 expressing a function fs (√areaₘₐₓ) obtained by multiplying the probability distribution function f (√areaₘₐₓ) and this function s (√areaₘₐₓ). Here, the area proportion s is a value obtained by dividing the area S (P, √areaₘₐₓ) by a cross-sectional area S₀ [μm²] of the cross section of the wire obtained by cutting the wire of the coil spring in a direction perpendicular to the circumferential direction (the helical direction) of the wire.

The index deriving unit 205 integrates the function fS (√areaₘₐₓ) over the inclusion size √areaₘₐₓ of the part with the whole region of the range where the probability distribution of the inclusion size √areaₘₐₓ exists set as an integral range. Then, the index deriving unit 205 derived a value obtained by multiplying a value obtained by diving the integrated result (namely a value obtained by integrating a value, which is obtained by multiplying an area of the graph 803 in FIG. 8 and the cross-sectional area S₀ [μm²] of the cross section of the wire, in the circumferential direction (the helical direction) of the wire) by the total volume of the wire obtained by cutting the wire of the coil spring in a direction perpendicular to the circumferential direction of the wire by 100 as the index FS (P) [%]. This index FS (P) is an index indicating the size of a “risk area of the coil spring” corresponding to the stress amplitude τₐ (r) of the shear stress to act repeatedly on each location of the wire in the case of the repeated load being applied in the extending and contracting direction of the coil spring 10⁷ times in the stress amplitude of the shear stress determined by the previously described nominal maximum shear stress τₘₐₓ on the surface of the spring.

Here, the area S (P, √areaₘₐₓ) can vary in proportion to the size of the part (the coil spring). In this example, the coil springs with the numbers of windings of 30 and 6 are made. Then, as for the coil spring with the number of windings of 30, a value obtained by multiplying a value obtained by dividing the integrated result (namely the area of the graph 803 in FIG. 8) by the cross-sectional area S₀ of the cross section of the wire obtained by cutting the wire of the coil spring in a direction perpendicular to the circumferential direction of the wire by 5 was derived as the index FS (P). On the other hand, as for the coil spring with the number of windings of 5, as described previously, a value obtained by dividing the integrated result (namely the area of the graph 803 in FIG. 8) by the cross-sectional area S₀ of the cross section of the wire obtained by cutting the wire of the coil spring in a direction perpendicular to the circumferential direction of the wire was derived as the index FS (P).

Then, in this example, the above derivations of the index FS (P) were performed in the case of the nominal maximum shear stress τₘₐₓ on the surface of the spring being 850 [MPa], 900 [MPa], 950 [MPa], and 1000 [MPa] each.

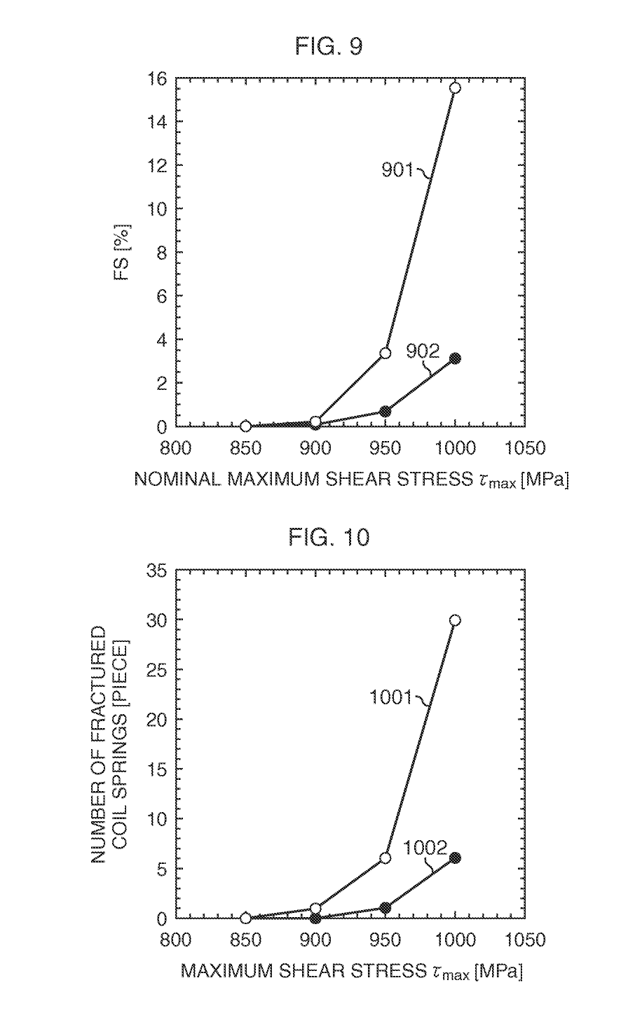

FIG. 9 is a view depicting the relationship between the index FS (P) and the nominal maximum shear stress τₘₐₓ on the surface of the spring. In FIG. 9, a graph 901 is a graph of the coil spring with the number of windings of 30, and a graph 902 is a graph of the coil spring with the number of windings of 6.

Next, a fatigue fracture test was performed on the same coil springs as those described previously.

First, the maximum shear stress on the surface of the coil spring was set to 1000 [MPa] and the minimum shear stress was set to 250 [MPa], and then a repeated loading test was performed 10⁷ [times]. As a result, as for the coil spring with the number of windings of 30, 30 out of the 30 coil springs fractured. On the other hand, as for the coil spring with the number of windings of 6, 6 out of the 30 coil springs fractured.

Next, the maximum shear stress on the surface of the coil spring was set to 950 [MPa] and the minimum shear stress was set to 237.5 [MPa], and then a repeated loading test was performed 10⁷ [times]. As a result, as for the coil spring with the number of windings of 30, 6 out of the 30 coil springs fractured. On the other hand, as for the coil spring with the number of windings of 6, 1 out of the 30 coil springs fractured.

Next, the maximum shear stress on the surface of the coil spring was set to 900 [MPa] and the minimum shear stress was set to 225 [MPa], and then a repeated loading test was performed 10⁷ [times]. As a result, as for the coil spring with the number of windings of 30, 1 out of the 60 coil springs fractured. On the other hand, as for the coil spring with the number of windings of 6, zero out of the 60 coil springs fractured.

Next, the maximum shear stress on the surface of the coil spring was set to 850 [MPa] and the minimum shear stress was set to 212.5 [MPa], and then a repeated loading test was performed 10⁷ [times]. As a result, as for the coil spring with the number of windings of 30, zero out of the 60 coil springs fractured. On the other hand, as for the coil spring with the number of windings of 6, zero out of the 60 coil springs fractured.

FIG. 10 is a view depicting the relationship between the number of fractured coil springs obtained from the result of the above fatigue fracture test and the maximum shear stress τₘₐₓ. In FIG. 10, a graph 1001 is a graph of the coil spring with the number of windings of 30, and a graph 1002 is a graph of the coil spring with the number of windings of 6.

It is found from FIG. 9 and FIG. 10 that after the boundary of the maximum shear stress τₘₐₓ being 900 [MPa], both the index FS (P) and the number of fractured coil springs tend to become large rapidly and the index FS (P) and the number of fractured coil springs show the same tendency. Thus, it is found that it is possible to predict the tendency of frequency of fatigue breakage starting from an inclusion of the coil spring by the index FS (P).

### Example 2

Next, Example 2 will be explained. In Example 2, there will be explained the example in the case when a rotary bending test in which a test piece is rotated while loading bending moment thereto and an axial tensile repeated stress to be increased in a surface direction from the axial center is caused to occur is performed.

In this example, a round bar test piece having had a compressive residual stress introduced to a surface thereof was used. As the material constituting the round bar test piece, a SUP12 (a silicon chromium steel) defined as a spring steel in JIS was used. The Vickers hardness Hv of this material is 550.

In this example, round bar test pieces having parallel portions of 10 [mm] and 50 [mm] in length, a parallel portion of 4 [mm] in diameter, and a grip portion of 12 [mm] in diameter were made of the above material. Each of these round bar test pieces had a similar shot peening process performed thereon and had a residual stress introduced to a surface thereof.

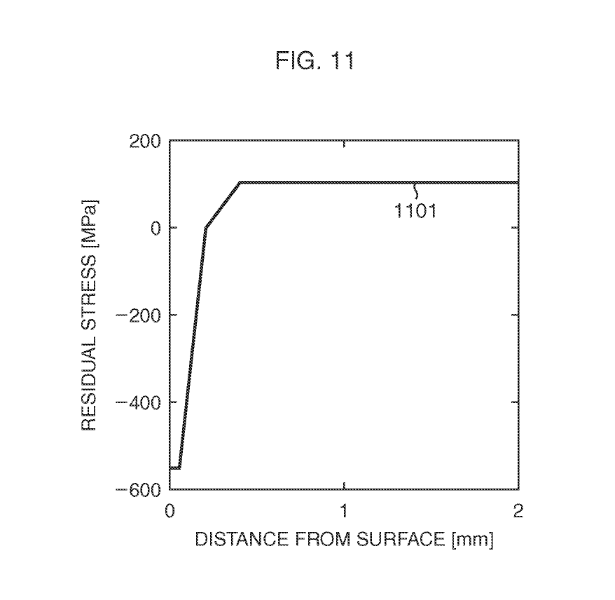

FIG. 11 is a view depicting the relationship between a distance (a depth) from the surface of the round bar test piece and a stress amplitude of the residual stress of the round bar test piece. In this example, a residual stress 1101 depicted in FIG. 11 is introduced to each of the round bar test pieces.

Thirty pieces of “hourglass-shaped test pieces for an ultrasonic fatigue test each having a test piece constricted portion of 3 [mm] in diameter,” each of which being formed of the previously described material, were made. Incidentally, a residual stress introduction process by shot peening is not performed on each of the hourglass-shaped test pieces. An ultrasonic fatigue test was performed by using 30 pieces of these hourglass-shaped test pieces (material fatigue test pieces). Then, the inclusion size √areaₘₐₓ was measured on each of cross sections of 30 pieces of the fatigue test pieces. Here, the shape of an inclusion being the starting point of a fatigue fracture portion was projected on a fracture surface, and a value obtained by taking the square root of an area of the inclusion made to approximate an elliptical shape was measured as the inclusion size √areaₘₐₓ.

The maximum size inclusion distribution function deriving unit 201 inputs the inclusion sizes √area_{max,j} measured in this manner and calculates the cumulative probability Fⱼ (√area_{max,j}) and the normalized variable yⱼ from (3) Expression and (4) Expression.

The maximum size inclusion distribution function deriving unit 201 aligns the input inclusion sizes √area_{max,j} in ascending order and sets the inclusion size √areaₘₐₓ to the value of the horizontal axis and sets the cumulative probability F (√areaₘₐₓ) and the normalized variable y to the value of the vertical axis to estimate a maximum inclusion probability distribution function indicating the relationship of them by using the least square method. Here, when the input inclusion sizes √areaₘₐₓ were expressed linearly and the cumulative probability F (√areaₘₐₓ) was expressed in a double logarithm, the linear distribution was obtained (similarly to Example 1), and thus this distribution was thought to be the shape parameter being zero (ξ=0), namely to be the Gumbel-type extreme value distribution and by using (1b) Expression, parameters of the maximum inclusion probability distribution function were estimated. As a result, as the scale parameter α, 2.9 was derived and as the location parameter λ, 19 was derived.

In this example, by an Ono-type rotary bending test machine, a rotary bending test was performed under the loading condition P of a rotary bending test being performed at a rotation speed of 3000 [rpm] so that a test piece surface stress amplitude might become 690 [MPa], 720 [MPa], and 750 [MPa]. The estimated fatigue strength deriving unit 202 assumed the inclusion size √areaₘₐₓ that may exceed the fatigue strength in consideration of a possibility of an inclusion having the size existing and a stress level of a member to be evaluated, varied the inclusion size √areaₘₐₓ at intervals of 1 [μm] in a range of 7 [μm] to 65 [μm], and substituted the stress ratio R provided by (14) Expression in the case of the inclusion size √areaₘₐₓ and the Vickers hardness Hv (=550) in (5) Expression and thereby derived the stress amplitude σ_{w} of the fatigue strength. Further, the acting stress amplitude deriving unit 203 derived “each of the inclusion sizes √areaₘₐₓ, the stress amplitude of the acting stress σ at each location of the round bar test piece” in the case of the repeated load being applied on the round bar test piece under the previously described loading condition P.

R={−x×(σ_{suf}/2)+σᵣₛ(x)}/{x×(σ_{suf}/2)+σᵣₛ(x)} (14)

In (14) Expression, x is a distance [mm] from the center of the round bar test piece, σ_{suf} is a stress amplitude [N/mm²] of a nominal maximum stress on the surface of the round bar test piece, and σᵣₛ (x) is a stress amplitude [N/mm²] of the residual stress at a distance x.

Then, the fatigue strength excess region deriving unit 204 compares the values of the “stress amplitude σ_{w} of the fatigue strength at each distance from the surface of the round bar test piece and the stress amplitude σ of the acting stress at each distance from the surface of the round bar test piece under the loading condition P” and derives a “volume S (P, √areaₘₐₓ) of a region of the round bar test piece” where the stress amplitude σ of the acting stress exceeds the stress amplitude σ_{w} of the fatigue strength at each location in the case of the repeated load being applied under the loading condition P. In this example, with respect to the single test piece surface stress amplitude, the volume S (P, √areaₘₐₓ) is derived in a manner to correspond to the inclusion size √areaₘₐₓ employed for deriving the stress amplitude σ_{w} of the fatigue strength. Incidentally, in the following explanation, the “volume S (P, √areaₘₐₓ)” is sometimes referred to as the “volume S” or “S (√areaₘₐₓ).”

The index deriving unit 205 substitutes the “scale parameter α and the location parameter λ” derived by the maximum size inclusion distribution function deriving unit 201 in (2) Expression and sets the probability distribution function f (√areaₘₐₓ). Then, the index deriving unit 205 derives a function S (√areaₘₐₓ) indicating the relationship between the volume S and the inclusion size √areaₘₐₓ from the volume S in each of the inclusion sizes √areaₘₐₓ. Then, the index deriving unit 205 derives a function fS (√areaₘₐₓ) obtained by multiplying the probability distribution function f (√areaₘₐₓ) and this function S (√areaₘₐₓ). The index deriving unit 205 integrates the function fS (√areaₘₐₓ) over the inclusion size √areaₘₐₓ of the part with the whole region of a range where the probability distribution of the inclusion size √areaₘₐₓ exists set as an integral range. Then, the index deriving unit 205 derived a value obtained by multiplying a value obtained by diving the integrated result by the volume of the parallel portion of the round bar test piece having the parallel portion of 10 [mm] in length by 100 as the index FS (P) [%]. In this example as above, as the index FS (P) corresponding to the round bar test pieces having the parallel portions of 10 [mm] and 50 [mm] in length, a value normalized by the volume of the parallel portion of the round bar test piece having the parallel portion having a relatively small length (the parallel portion of 10 [mm] in length) is derived. Further, this index FS (P) is an index indicating the size of a “risk volume of the round bar test piece” corresponding to the acting stress σ to act repeatedly on each location of the round bar test piece when being subjected to the repeated load 10⁷ times in the previously described test piece surface stress amplitude to have the rotary bending test performed thereon.

Then, in this example, the above derivation of the index FS (P) was performed in the case of the test piece surface stress amplitude being 690 [MPa], 720 [MPa], and 750 [MPa] each.

Next, a rotary bending test was performed on the same round bar test pieces as those described previously under the previously described condition.

First, the stress amplitude on the surface of the round bar test piece was set to 690 [MPa] and a repeated rotary bending test was performed 10⁷ [times]. As a result, as for the round bar test piece having the parallel portion of 10 [mm] in length, zero out of the 30 round bar test pieces fractured (not a round bar test piece fractured). On the other hand, as for the round bar test piece having the parallel portion of 50 [mm] in length, zero out of the 30 round bar test pieces fractured (not a round bar test piece fractured).

Next, the stress amplitude on the surface of the round bar test piece was set to 720 [MPa] and a repeated rotary bending test was performed 10⁷ [times]. As a result, as for the round bar test piece having the parallel portion of 10 [mm] in length, 1 out of the 30 round bar test pieces fractured. On the other hand, as for the round bar test piece having the parallel portion of 50 [mm] in length, 5 out of the round bar test pieces fractured.

Next, the stress amplitude on the surface of the round bar test piece was set to 750 [MPa] and a repeated rotary bending test was performed 10⁷ [times]. As a result, as for the round bar test piece having the parallel portion of 10 [mm] in length, 4 out of the 30 round bar test pieces fractured. On the other hand, as for the round bar test piece having the parallel portion of 50 [mm] in length, 16 out of the round bar test pieces fractured.

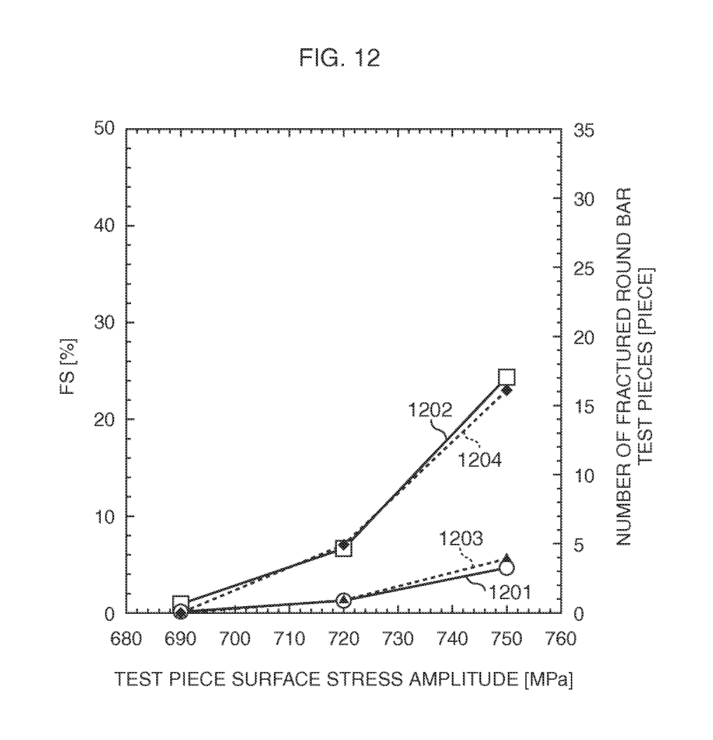

FIG. 12 is a view depicting the relationship between the index FS (P) and the number of fractured round bar test pieces obtained as above and the test piece surface stress amplitude. In FIG. 12, a graph 1201 indicates the index FS (P) of the round bar test piece having the parallel portion of 10 [mm] in length and a graph 1202 indicates the index FS (P) of the round bar test piece having the parallel portion of 50 [mm] in length. Further, a graph 1203 indicates the number of fractured round bar test pieces with respect to the round bar test piece having the parallel portion of 10 [mm] in length and a graph 1204 indicates the number of fractured round bar test pieces with respect to the round bar test piece having the parallel portion of 50 [mm] in length.

As depicted in FIG. 12, tendencies of the graph 1201 and the graph 1203 substantially agree with each other and tendencies of the graph 1202 and the graph 1204 substantially agree with each other. Thus, it is found that the result of fatigue fracture by the rotary bending test can be estimated by the index FS (P) and the effect of the volume of the round bar test piece on fracture can also be made clear.

### Example 3

Next, Example 3 will be explained. In this example, similarly to Example 2, there will be explained the example in the case when a rotary bending test in which a test piece is rotated while loading bending moment thereto and an axial tensile repeated stress to be increased in a surface direction from the axial center is caused to occur is performed.

In this example as well, a round bar test piece having had a compressive residual stress substantially similar to that in Example 2 introduced to a surface thereof was used. As the material constituting the round bar test piece, a defined material similar to that in Example 2 was used. However, while the Vickers hardness Hv of the material used in Example 2 is 550, the Vickers hardness Hv of this material is 530.

In this example as well, round bar test pieces having parallel portions of 10 [mm] and 50 [mm] in length, a parallel portion of 4 [mm] in diameter, and a grip portion of 12 [mm] in diameter were made of the above material. Each of these round bar test pieces had a similar shot peening process performed thereon and had a residual stress similar to that in Example 2 introduced to a surface thereof (see FIG. 11).

Thirty pieces of “hourglass-shaped test pieces for an ultrasonic fatigue test each having a test piece constricted portion of 3 [mm] in diameter,” each of which being formed of the previously described material, were made. An ultrasonic fatigue test was performed by using 30 pieces of these hourglass-shaped test pieces (material fatigue test pieces) and the derivation of a maximum inclusion probability distribution function was performed.

Similarly to Example 2, the inclusion size √areaₘₐₓ was measured on each of cross sections of 30 pieces of these fatigue test pieces. Here, the shape of an inclusion being the starting point of a fatigue fracture portion was projected on a fracture surface, and a value obtained by taking the square root of an area of the inclusion made to approximate an elliptical shape was measured as the inclusion size √areaₘₐₓ.

The maximum size inclusion distribution function deriving unit 201 inputs the inclusion sizes √area_{max,j} measured in this manner and calculates the cumulative probability Fⱼ (√area_{max,j}) and the normalized variable yⱼ from (3) Expression and (4) Expression.

The maximum size inclusion distribution function deriving unit 201 aligns the input inclusion sizes √area_{max,j} in ascending order and sets the inclusion size √areaₘₐₓ to the value of the horizontal axis and sets the cumulative probability F (√areaₘₐₓ) and the normalized variable y to the value of the vertical axis to estimate a maximum inclusion probability distribution function indicating the relationship of them. In Example 2, as for the estimation of the maximum inclusion probability distribution function, ξ=0 was set and the straight-line approximation was performed by using the least square method, but in this example, the estimation of the maximum inclusion probability distribution function was performed by using the maximum likelihood method. Further, here, when the input inclusion sizes √areaₘₐₓ were expressed linearly and the cumulative probability F (√areaₘₐₓ) was expressed in a double logarithm, there was shown a tendency that the maximum inclusion size √areaₘₐₓ hits the peak, and thus this distribution was thought to be the shape parameter being a negative value (ξ<0), namely to be the Weibull-type extreme value distribution and by using (1a) Expression, parameters of the maximum inclusion probability distribution function were estimated. As a result, as the scale parameter α, 3.2 was derived, as the location parameter λ, 23 was derived, and as the shape parameter ξ, −0.1 was derived.

In this example, by an Ono-type rotary bending test machine, a rotary bending test was performed under the loading condition P of a rotary bending test being performed at a rotation speed of 3000 [rpm] so that a test piece surface stress amplitude might become 650 [MPa], 680 [MPa], and 710 [MPa]. The estimated fatigue strength deriving unit 202, similarly to Example 2, varied the inclusion size √areaₘₐₓ at intervals of 1 [μm] in a range of 7 [μm] to 65 [μm] and substituted the stress ratio R provided by (14) Expression in the case of the inclusion size √areaₘₐₓ and the Vickers hardness Hv (=530) in (5) Expression to thereby derive the stress amplitude σ_{w} of the fatigue strength. Further, the acting stress amplitude deriving unit 203 derived “each of the inclusion sizes √areaₘₐₓ, the stress amplitude of the acting stress σ at each location of the round bar test piece” in the case of the repeated load being applied on the round bar test piece under the previously described loading condition P.

Then, the fatigue strength excess region deriving unit 204 compares the values of the “stress amplitude of the fatigue strength at each distance from the surface of the round bar test piece and the stress amplitude σ of the acting stress at each distance from the surface of the round bar test piece under the loading condition P” and derives the “volume S (P, √areaₘₐₓ) of the region of the round bar test piece” where the stress amplitude σ of the acting stress exceeds the stress amplitude σ_{w} of the fatigue strength at each location in the case of the repeated load being applied under the loading condition P. In this example as well, similarly to Example 2, with respect to the single test piece surface stress amplitude, the volumes S (P, √areaₘₐₓ) equivalent to the number of the inclusion sizes √areaₘₐₓ employed for deriving the stress amplitude σ_{w} of the fatigue strength are derived. Incidentally, in the following explanation, the “volume S (P, √areaₘₐₓ)” is sometimes referred to as the “volume S” or “S (√areaₘₐₓ).”

The index deriving unit 205 substitutes the “scale parameter α and the location parameter λ” derived by the maximum size inclusion distribution function deriving unit 201 in (2) Expression and sets the probability distribution function f (√areaₘₐₓ). Then, the index deriving unit 205 derives the function S (√areaₘₐₓ) indicating the relationship between the volume S and the inclusion size √areaₘₐₓ from the volume S in each of the inclusion sizes √areaₘₐₓ. Then, the index deriving unit 205 derives the function fS (√areaₘₐₓ) obtained by multiplying the probability distribution function f (√areaₘₐₓ) and this function S (√areaₘₐₓ). The index deriving unit 205 integrates the function fS (√areaₘₐₓ) over the inclusion size √areaₘₐₓ of the part with the whole region of a range where the probability distribution of the inclusion size √areaₘₐₓ exists set as an integral range. Then, the index deriving unit 205 derived a value obtained by multiplying a value obtained by diving the integrated result by the volume of the parallel portion of the round bar test piece having the parallel portion of 10 [mm] in length by 100 as the index FS (P) [%]. In this example as well, as described above, similarly to Example 2, as the index FS (P) corresponding to the round bar test pieces having the parallel portions of [mm] and 50 [mm] in length, a value normalized by the volume of the parallel portion of the round bar test piece having the parallel portion having a relatively small length (the parallel portion of 10 [mm] in length) is derived.

Then, in this example as well, similarly to Example 2, the above derivation of the index FS (P) was performed in the case of the test piece surface stress amplitude being 690 [MPa], 720 [MPa], and 750 [MPa] each.

Next, a rotary bending test was performed on the same round bar test pieces as those described previously under the previously described condition.

First, the stress amplitude on the surface of the round bar test piece was set to 650 [MPa] and a repeated rotary bending test was performed 10⁷ [times]. As a result, as for the round bar test piece having the parallel portion of 10 [mm] in length, zero out of the 30 round bar test pieces fractured (not a round bar test piece fractured). On the other hand, as for the round bar test piece having the parallel portion of 50 [mm] in length, zero out of the 30 round bar test pieces fractured (not a round bar test piece fractured).

Next, the stress amplitude on the surface of the round bar test piece was set to 680 [MPa] and a repeated rotary bending test was performed 10⁷ [times]. As a result, as for the round bar test piece having the parallel portion of 10 [mm] in length, 1 out of the 30 round bar test pieces fractured. On the other hand, as for the round bar test piece having the parallel portion of 50 [mm] in length, 5 out of the round bar test pieces fractured.

Next, the stress amplitude on the surface of the round bar test piece was set to 710 [MPa] and a repeated rotary bending test was performed 10⁷ [times]. As a result, as for the round bar test piece having the parallel portion of 10 [mm] in length, 5 out of the 30 round bar test pieces fractured. On the other hand, as for the round bar test piece having the parallel portion of 50 [mm] in length, 18 out of the round bar test pieces fractured.

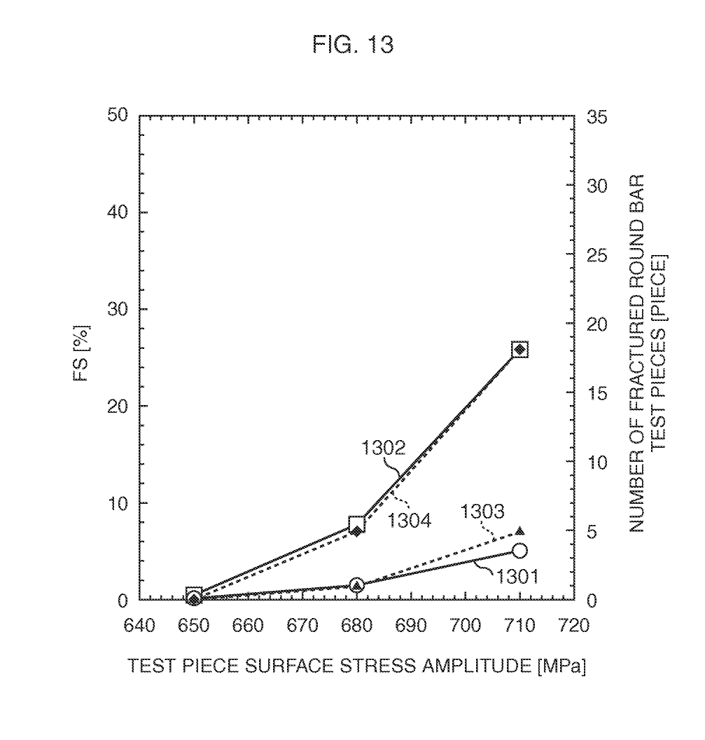

FIG. 13 is a view depicting the relationship between the index FS (P) and the number of fractured round bar test pieces obtained as above and the test piece surface stress amplitude. In FIG. 13, a graph 1301 indicates the index FS (P) of the round bar test piece having the parallel portion of 10 [mm] in length and a graph 1302 indicates the index FS (P) of the round bar test piece having the parallel portion of 50 [mm] in length. Further, a graph 1303 indicates the number of fractured round bar test pieces with respect to the round bar test piece having the parallel portion of 10 [mm] in length and a graph 1304 indicates the number of fractured round bar test pieces with respect to the round bar test piece having the parallel portion of 50 [mm] in length.

As depicted in FIG. 13, tendencies of the graph 1301 and the graph 1303 substantially agree with each other and tendencies of the graph 1302 and the graph 1304 substantially agree with each other. Thus, it is found that the result of fatigue fracture by the rotary bending test can be estimated by the index FS (P) and the effect of the volume of the round bar test piece on fracture can also be made clear.

Note that the above-described embodiment of the present invention can be implemented by a computer executing a program. Further, a means for supplying the program to the computer, for example, a computer-readable recording medium such as a CD-ROM or the like having such a program recorded thereon, or a transmission medium transmitting such a program is also applicable as the embodiment of the present invention. Furthermore, a program product such as a computer-readable recording medium having the above-described program recorded thereon is also applicable as the embodiment of the present invention. The above-described program, computer-readable recording medium, transmission medium, and program product are included in the scope of the present invention.

Further, it should be noted that the above-explained embodiments merely illustrate concrete examples of implementing the present invention, and the technical scope of the present invention is not to be construed in a restrictive manner by these embodiments. That is, the present invention may be implemented in various forms without departing from the technical spirit or main features thereof.

### INDUSTRIAL APPLICABILITY

The present invention can be utilized in fatigue design of a machine part, for example.

1. A part fatigue fracture evaluating apparatus evaluating fatigue inside a machine part when being subjected to a repeated load, the part fatigue fracture evaluating apparatus comprising:
a maximum size inclusion distribution function deriving means that inputs a plurality of values of an inclusion size, each being a value obtained by taking the square root of a cross-sectional area of an inclusion obtained by projecting the shape of, among inclusions existing inside the machine part, the maximum inclusion in a reference volume on a plane, or a value obtained by taking the square root of an estimated value of a cross-sectional area of an inclusion obtained from, in the case when among inclusions existing inside the machine part, the shape of the maximum inclusion in a reference volume is made to approximate a predetermined figure, a representative size of the figure, and based on the input plural inclusion sizes, derives a probability distribution function of the inclusion size with a maximum value distribution, of the inclusion size, in the machine part set to follow a generalized extreme value distribution;
an estimated fatigue strength deriving means that inputs values of the inclusion size, hardness of the machine part or strength of a material of the machine part, and a stress ratio of the machine part each and as a fatigue strength, being a fatigue strength starting from an inclusion existing in the machine part, corresponding to a predetermined number of repeated times of a predetermined load to be loaded repeatedly, substitutes the input values in an expression of a fatigue strength expressed by the inclusion size, the hardness of the machine part or strength of the material of the machine part, and the stress ratio of the machine part to derive the fatigue strength at each location of the machine part;
an acting stress amplitude deriving means that derives a stress amplitude of an acting stress to act on each location inside the machine part when being subjected to a repeated load under a loading condition set previously;
a fatigue strength excess region deriving means that derives the size of, of a region of the machine part, a region where the stress amplitude of the acting stress exceeds the fatigue strength based on a result obtained by comparing the fatigue strength derived by said estimated fatigue strength deriving means and the stress amplitude of the acting stress derived by said acting stress amplitude deriving means;
an index deriving means that derives an index for evaluating the fatigue inside the machine part based on the product of the probability distribution function of the inclusion size and the size of the region where the stress amplitude of the acting stress exceeds the fatigue strength; and
an index outputting means that outputs the index derived by said index deriving means.

2. The part fatigue fracture evaluating apparatus according to claim 1, wherein
said index deriving means derives, as the index, a value obtained by integrating the product of the probability distribution function of the inclusion size and the size of the region where the stress amplitude of the acting stress exceeds the fatigue strength over the inclusion size of the part with the whole region of a range where a probability distribution of the inclusion size exists set as an integral range.

3. The part fatigue fracture evaluating apparatus according to claim 1, wherein
the stress amplitude of the acting stress is an amplitude of a corresponding stress at each location of the machine part, or an amplitude of a principal stress in a direction in which variation in the principal stress at each location of the machine part becomes maximum, and
the stress ratio is a stress ratio of a corresponding stress at each location of the machine part, or a stress ratio of a principal stress in a direction in which variation in the principal stress at each location of the machine part becomes maximum.

4. A part fatigue fracture evaluating method evaluating fatigue inside a machine part when being subjected to a repeated load by using a computer, the part fatigue fracture evaluating method comprising:
a maximum size inclusion distribution function deriving step of inputting a plurality of values of an inclusion size, each being a value obtained by taking the square root of a cross-sectional area of an inclusion obtained by projecting the shape of, among inclusions existing inside the machine part, the maximum inclusion in a reference volume on a plane, or a value obtained by taking the square root of an estimated value of a cross-sectional area of an inclusion obtained from, in the case when among inclusions existing inside the machine part, the shape of the maximum inclusion in a reference volume is made to approximate a predetermined figure, a representative size of the figure, and based on the input plural inclusion sizes, deriving a probability distribution function of the inclusion size with a maximum value distribution, of the inclusion size, in the machine part set to follow a generalized extreme value distribution;
an estimated fatigue strength deriving step of inputting values of the inclusion size, hardness of the machine part or strength of a material of the machine part, and a stress ratio of the machine part each and as a fatigue strength, being a fatigue strength starting from an inclusion existing in the machine part, corresponding to a predetermined number of repeated times of a predetermined load to be loaded repeatedly, substituting the input values in an expression of a fatigue strength expressed by the inclusion size, the hardness of the machine part or strength of the material of the machine part, and the stress ratio of the machine part to derive the fatigue strength at each location of the machine part;
an acting stress amplitude deriving step of deriving a stress amplitude of an acting stress to act on each location inside the machine part when being subjected to a repeated load under a loading condition set previously;
a fatigue strength excess region deriving step of deriving the size of, of a region of the machine part, a region where the stress amplitude of the acting stress exceeds the fatigue strength based on a result obtained by comparing the fatigue strength derived by said estimated fatigue strength deriving step and the stress amplitude of the acting stress derived by said acting stress amplitude deriving step;
an index deriving step of deriving an index for evaluating the fatigue inside the machine part based on the product of the probability distribution function of the inclusion size and the size of the region where the stress amplitude of the acting stress exceeds the fatigue strength; and
an index outputting step of outputting the index derived by said index deriving step.

5. The part fatigue fracture evaluating method according to claim 4, wherein
said index deriving step derives, as the index, a value obtained by integrating the product of the probability distribution function of the inclusion size and the size of the region where the stress amplitude of the acting stress exceeds the fatigue strength over the inclusion size of the part with the whole region of a range where a probability distribution of the inclusion size exists set as an integral range.

6. The part fatigue fracture evaluating method according to 4, wherein
the stress amplitude of the acting stress is an amplitude of a corresponding stress at each location of the machine part, or an amplitude of a principal stress in a direction in which variation in the principal stress at each location of the machine part becomes maximum, and
the stress ratio is a stress ratio of a corresponding stress at each location of the machine part, or a stress ratio of a principal stress in a direction in which variation in the principal stress at each location of the machine part becomes maximum.

7. A computer program product for causing a computer to execute evaluation of fatigue inside a machine part when being subjected to a repeated load by using a computer, the computer program product for casing the computer to execute:
a maximum size inclusion distribution function deriving step of inputting a plurality of values of an inclusion size, each being a value obtained by taking the square root of a cross-sectional area of an inclusion obtained by projecting the shape of, among inclusions existing inside the machine part, the maximum inclusion in a reference volume on a plane, or a value obtained by taking the square root of an estimated value of a cross-sectional area of an inclusion obtained from, in the case when among inclusions existing inside the machine part, the shape of the maximum inclusion in a reference volume is made to approximate a predetermined figure, a representative size of the figure, and based on the input plural inclusion sizes, deriving a probability distribution function of the inclusion size with a maximum value distribution, of the inclusion size, in the machine part set to follow a generalized extreme value distribution;
an estimated fatigue strength deriving step of inputting values of the inclusion size, hardness of the machine part or strength of a material of the machine part, and a stress ratio of the machine part each and as a fatigue strength, being a fatigue strength starting from an inclusion existing in the machine part, corresponding to a predetermined number of repeated times of a predetermined load to be loaded repeatedly, substituting the input values in an expression of a fatigue strength expressed by the inclusion size, the hardness of the machine part or strength of the material of the machine part, and the stress ratio of the machine part to derive the fatigue strength at each location of the machine part;
an acting stress amplitude deriving step of deriving a stress amplitude of an acting stress to act on each location inside the machine part when being subjected to a repeated load under a loading condition set previously;
a fatigue strength excess region deriving step of deriving the size of, of a region of the machine part, a region where the stress amplitude of the acting stress exceeds the fatigue strength based on a result obtained by comparing the fatigue strength derived by said estimated fatigue strength deriving step and the stress amplitude of the acting stress derived by said acting stress amplitude deriving step;
an index deriving step of deriving an index for evaluating the fatigue inside the machine part based on the product of the probability distribution function of the inclusion size and the size of the region where the stress amplitude of the acting stress exceeds the fatigue strength; and
an index outputting step of outputting the index derived by said index deriving step.
